(19) United States
(12) Patent Application Publication
(10) Pub. No.: US 2019/0072209 A1
(43) Pub. Date: Mar. 7, 2019

(54) WATER SOFTENER VALVE AND WATER TREATMENT APPARATUS

(71) Applicants: FOSHAN MIDEA CHUNGHO WATER PURIFICATION EQUIPMENT CO., LTD., Foshan (CN); FOSHAN SHUNDE MIDEA WATER DISPENSER MANUFACTURING CO., LTD., Foshan (CN); MIDEA GROUP CO., LTD., Foshan (CN)

(72) Inventors: Guohua LIU, Foshan (CN); Zhifeng He, Foshan (CN)

(21) Appl. No.: 16/179,947

(22) Filed: Nov. 4, 2018

(30) Foreign Application Priority Data
Apr. 28, 2018 (CN) 201810409325.3
Apr. 28, 2018 (CN) 201820641612.2
Apr. 28, 2018 (CN) 201820641821.7
Apr. 28, 2018 (CN) 201820646246.X
Apr. 28, 2018 (CN) 201820948357.6
Apr. 28, 2018 (CN) 201820948406.6
Apr. 28, 2018 (CN) 201820948410.2
Apr. 28, 2018 (CN) 201820948411.7

(51) Int. Cl. F16K 31/524; F16K 31/53; C02F 1/52; C02F 1/42; F16K 27/04; F16K 11/18; F16K 31/16

(52) U.S. Cl. CPC F16K 31/52475; F16K 31/53; C02F 1/5245; C02F 1/42; C02F 2209/40; F16K 11/18; F16K 31/16; C02F 2303/16; F16K 27/041

(57) ABSTRACT

Disclosed are a water softener valve and a water treatment apparatus. The water softener valve includes: a valve body, a multi-way valve, a saline solution suction and water injection valve and a driving mechanism, the saline solution suction and water injection valve including a first valve rod, the driving mechanism including a mounting seat and a cam, the end of the first valve rod extending out of the valve body being transmission cooperated with the cam, wherein, the mounting seat is defined with a sliding connection structure, the outer end of the first valve rod is sliding fit with the sliding connection structure along the longitudinal direction, and the outer end of the first valve rod is position-limiting cooperated with the sliding connection structure along the lateral direction; the longitudinal direction coincides with the length direction of the first valve rod.

### CROSS-REFERENCE TO RELATED APPLICATIONS

This application claims a priority to and benefits of Chinese Patent Application Serial No. 201820948357, 201820948411.7, 201820948410.2, 201820948406.6, 201820641821.7, 201820646246.X, 201810409325.3 and 201820641612.2, filed with the State Intellectual Property Office of P. R. China on Apr. 28, 2018, the entire contents of which are incorporated herein by reference.

### FIELD

The present disclosure relates to the field of water treatment apparatus, and more particularly relates to a water softener valve and a water treatment apparatus.

### BACKGROUND

A water softener can soften the water, thereby improving the users' water quality experience, saving detergent, saving water and so on. A core component of the water softener is water softener valve. The water softener valve has the function of switching different water passages among water purification, backwashing, saline solution suction regeneration, forward washing, and water injection. The saline solution suction regeneration is implemented by controlling a water injection piston of a saline solution suction and water injection valve connected to a valve rod to reciprocate. The reciprocating of the water injection piston relies on a sliding fit of the valve rod and a valve body. The current valve rod includes gaskets and springs fixed on the valve body, therefore, a lot of components are needed to be assembled. However, the assembled lots of components are prone to looseness and causing an instable movement of the valve rod.

### SUMMARY

One embodiment of the present disclosure to provide a water softener valve, aiming to solve the problem that the existing assembled valve rod and valve body of the saline solution suction and water injection valve are prone to looseness resulting an instable movement of the valve rod.

As such, the present disclosure provides a water softener valve, including a valve body, a multi-way valve, a saline solution suction and water injection valve and a driving mechanism. The saline solution suction and water injection valve includes a first valve rod, the driving mechanism includes a mounting seat and a cam. The end of the first valve rod extending out of the valve body is in a transmission cooperation with the cam. The mounting seat is provided with a sliding connection structure, the outer end of the first valve rod is sliding fit with the sliding connection structure along the longitudinal direction, and the outer end of the first valve rod is in a position-limiting cooperation with the sliding connection structure along the lateral direction. The longitudinal direction coincides with the length direction of the first valve rod, the lateral direction is perpendicular to the longitudinal direction and the axial direction of the cam.

In one embodiment, the sliding cooperation portion is further provided with a transmission surface that connects the two sliding connection surfaces and facing the cam, the transmission surface is provided with a transmission shaft, the cam is provided with a transmission groove adapted to the transmission shaft.

In one embodiment, the mounting seat includes a first mounting plate, the side of the first mounting plate facing the cam is recessed to provide a sliding groove extending along the longitudinal direction, the two guiding surfaces are respectively disposed on the two opposite inner wall surfaces of the sliding groove, the sliding cooperation portion is sliding fit with the sliding groove.

In one embodiment, the sliding groove includes a bottom wall opposite to the cam, the bottom wall is opened with an observation hole extending along the longitudinal direction, and the bottom wall is provided with an indication scale on at least one side of the observation hole in the lateral direction.

In one embodiment, the transmission surface is flush with the side of the first valve rod facing the cam and adjacent to the cam, the sliding connection surface extends away from the cam.

In one embodiment, the first valve rod includes a rod portion, the sliding cooperation portion includes a sliding block arranged to be hollow and disposed at an end of the rod portion, the end of the rod portion extends in the inner cavity of the sliding block and connects to the sliding block, the side of the sliding block facing the bottom wall is opened with a through hole corresponding to the observation hole.

In one embodiment, the multi-way valve includes a second valve rod, the driving mechanism further includes a driving wheel and a driven wheel, the driving wheel is in a transmission cooperation with the outer end of the second valve rod, the driven wheel is in a transmission connection with the driving wheel and the cam, to allow the first valve rod and the second valve rod to form a linkage movement.

The present disclosure further provides a water softener, the water softener includes a water softener valve. The water softener valve includes a valve body, a multi-way valve, a saline solution suction and water injection valve and a driving mechanism. The saline solution suction and water injection valve includes a first valve rod, the driving mechanism includes a mounting seat and a cam, the end of the first valve rod extending out of the valve body is in a transmission cooperation with the cam. The mounting seat is defined with a sliding connection structure, the outer end of the first valve rod is sliding fit with the sliding connection structure along the longitudinal direction, and the outer end of the first valve rod is in a position-limiting cooperation with the sliding connection structure in the lateral direction. The longitudinal direction coincides with the length direction of the first valve rod, the lateral direction is perpendicular to the longitudinal direction and the axial direction of the cam.

The present disclosure further provides a water softener valve, includes:

a valve body, having a water-passing passage and communicating with one end of the water-passing passage, the valve body is provided with a plug interface extending through the side wall of the water-passing passage and adjacent to the water-passing port;

a water-passing connector, plugged in the water-passing port, two ends of the water-passing connector being cut-through and the water-passing connector communicating with the water-passing passage; and

a fixing member, plugged in the plug interface, and clamped at the portion of the water-passing connector located in the water-passing passage, to at least limit the position of the water-passing connector in the axial direction of the water-passing connector.

In one embodiment, the outer peripheral wall of the water-passing connector is provided with a clamping groove, the pin is clamped in the clamping groove.

In one embodiment, two ends of the connecting plate respectively protrude from the outer sides of the two pins.

In one embodiment, the valve body is opened with a clamping connector extending through the side wall of the water-passing passage, the clamping connector is away from the plug interface, the free end of the pin is clamped in the clamping connector.

In one embodiment, the valve body is further provided with a protruding block adjacent to the plug interface, the protruding block is provided with a clamping hole, and the connecting plate is provided with a clamping protrusion adapted to the clamping hole.

In one embodiment, the portions of the connecting plate facing toward or facing away the protruding block are provided with the clamping protrusions.

In one embodiment, the water-passing passage includes a water-inlet passage and/or a water-outlet passage.

The present disclosure further includes a water treatment apparatus. The water treatment apparatus includes an ion exchange tank and a water softener valve, the water softener valve includes: a valve body, having a water-passing passage and communicating with one end of the water-passing passage, the valve body is provided with a plug interface extending through the side wall of the water-passing passage and adjacent to the water-passing port; a water-passing connector, plugged in the water-passing port, two ends of the water-passing connector being cut-through and the water-passing connector communicating with the water-passing passage; and a fixing member, plugged in the plug interface, and clamped at the portion of the water-passing connector located in the water-passing passage, to at least limit the position of the water-passing connector in the axial direction of the water-passing connector. The water softener valve is mounted in the ion exchange tank, to allow the inner cavity of the valve body to communicating with the inner cavity of the ion exchange tank.

The present disclosure further provides a water softener valve, including a piston assembly, the piston assembly includes a piston body, a piston rod, a connecting member and a fastening member. The piston body is in an integrate structure, the piston assembly defines a water-passing passage extending along the telescopic direction of the piston rod and two ends through the piston assembly, the connecting member is disposed on the piston rod, the connecting member is in a position-limiting cooperation with the piston rod in the telescopic direction, the fastening member cooperates with the piston body to limit the connecting member in the telescopic direction. The connecting member is in a position-limiting cooperation with the piston rod in the telescopic direction. The fastening member is cooperated with the piston body to limit the position of the connecting member in the telescopic direction.

In one embodiment, the piston body is provided with an inner cavity extending along the telescopic direction of the piston rod and two cut-through ends, the inner wall of the inner cavity is provided with a stepped surface. The fastening member is annularly disposed and embedded in the inner cavity. An annular space formed between the inner annular surface of the fastening member and the outer peripheral surface of the piston rod, communicates with the inner cavity. The connecting member is clamped between the stepped surface and the fastening member.

In one embodiment, the fixing member is detachably cooperated with the piston body.

In one embodiment, the fixing member is threaded with the piston body.

In one embodiment, the end surface of the fixing member facing away from the stepped surface is opened with a clamping notch.

In one embodiment, the surface of the fixing member facing the stepped surface is opened with a limiting notch, the connecting member is clamped in the limiting notch.

The present disclosure further provides a water softener, the water softener includes a water softener valve. The water softener includes a water softener valve piston assembly, the water softener valve piston assembly includes a piston body, a piston rod, a connecting member and a fastening member. The piston body is in an integrate structure. The piston assembly is provided with a water-passing passage extending along the telescopic direction of the piston rod and two ends through. The connecting member is disposed on the piston rod. The connecting member is in a position-limiting cooperation with the piston rod in the telescopic direction. The fastening member is cooperated with the piston body to limit the position of the connecting member in the telescopic direction.

The present disclosure further provides a water softener valve, including a piston assembly. The piston assembly includes a piston body and a piston rod. The water softener valve further includes a piston rod sealing structure of the water softener valve, including: a valve body, including a main body and an end cap, the main body having a valve cavity with one end open, the end cap covering the open of the valve cavity, the end cap being provided with a mounting hole for the piston rod to come in or out of the valve cavity; a sealing ring, annually disposed at the edge of the mounting hole and configured to be in sealing cooperation with the piston rod; and a fixing member, fixedly connected to the end cap, to fix the sealing ring. The piston body is located in the valve cavity, the piston rod is sealingly cooperated with the sealing ring and plugged in the mounting hole retractably, and the inner end of the piston rod connects to the piston body.

In one embodiment, the bottom wall of the mounting groove is recessed to provide a sealing groove extending along the circumferential direction of the mounting hole, and the sealing ring is disposed in the sealing groove.

In one embodiment, the outer surface of the end cap is provided with a mounting post, the mounting groove is opened at the top of the mounting post.

In one embodiment, the mounting post and the end cap are in an integrate structure.

In one embodiment, the side of the mounting post facing away the mounting groove is arranged to be hollow to form a positioning groove, the positioning groove communicates with the mounting groove via the mounting hole.

In one embodiment, the fixing member is detachably fixed in the mounting groove.

In one embodiment, the fixing member is threaded with the mounting groove.

In one embodiment, the upper end of the fixing member protrudes from the mounting groove and extends outward along the radial direction to form a assembly knob.

The present disclosure further provides a water treatment apparatus, including an ion exchange tank and a water softener valve as described above. The water softener valve is mounted in the ion exchange tank to allow the valve cavity to communicate with the inner cavity of the ion exchange tank.

The present disclosure further provides a water softener valve, including a valve body, a multi-way valve, a saline solution suction and water injection valve and a driving mechanism. The driving mechanism includes a housing, a first cam, a second cam and a transmission shaft. The multi-way valve and the first cam are in a transmission cooperation, the saline solution suction and water injection valve and the second cam are in a transmission cooperation, the inner cavity of the housing is provided with a first mounting surface. The axes of the first cam, the second cam and the driving shaft are arranged in parallel with each other, the outer peripheral surfaces of the first cam and the second cam are provided with gear rack rows, the transmission shaft is located between the first cam and the second cam, the transmission shaft is provided with a first tooth segment engaged with the first cam, and a second tooth segment engaged with the second cam, the first cam is adjacent to the first mounting surface, the second cam and the first mounting surface defines a mounting space therebetween.

In one embodiment, the sliding cooperation portion is further provided with a transmission surface that connects the two sliding connection surfaces and facing the cam, the transmission surface is provided with a transmission shaft, the cam is provided with a transmission groove adapted to the transmission shaft.

In one embodiment, the mounting seat includes a first mounting plate, the side of the first mounting plate facing the cam is recessed to provide a sliding groove extending along the longitudinal direction, the two guiding surfaces are respectively disposed on the two opposite inner wall surfaces of the sliding groove, the sliding cooperation portion is sliding fit with the sliding groove.

In one embodiment, the sliding groove includes a bottom wall opposite to the cam, the bottom wall is opened with an observation hole extending along the longitudinal direction, and the bottom wall is provided with an indication scale on at least one side of the observation hole in the lateral direction.

In one embodiment, the transmission surface is flush with the side of the first valve rod facing the cam and adjacent to the cam, the sliding connection surface extends away from the cam.

In one embodiment, the first valve rod includes a rod portion, the sliding cooperation portion includes a sliding block defined to be hollow and disposed at an end of the rod portion, the end of the rod portion extends in the inner cavity of the sliding block and connects to the sliding block, the side of the sliding block facing the bottom wall is opened with a through hole corresponding to the observation hole.

In one embodiment, the multi-way valve includes a second valve rod, the driving mechanism further includes a driving wheel and a transmission wheel, the driving wheel is in a transmission cooperation with the outer end of the second valve rod, the transmission wheel is in a transmission connection with the driving wheel and the cam, to allow the first valve rod to move in conjunction with the second valve rod.

In one embodiment, the inner cavity of the housing is provided with a second mounting surface facing the first mounting surface, the outer end of the valve rod of the saline solution suction and water injection valve is located between the second mounting surface and the second cam.

In one embodiment, the inner cavity of the housing is provided with a third mounting surface facing the first mounting surface, the third mounting surface is closer to the first mounting surface than the second mounting surface, the outer end of the valve rod of the multi-way valve is located between the third mounting surface and the second cam.

In one embodiment, the driving mechanism further includes a speed reducer group. The housing is provided with an via hole penetrating through the third mounting surface, the speed reducer group includes a main body and an output shaft. The main body is located outside the housing, the output shaft passes through the via hole and engages with the gear rack row on the outer peripheral surface of the first cam.

In one embodiment, the driving mechanism further includes a circuit board and an electronic component disposed on the circuit board. The circuit board is located between the first cam and the first mounting surface, the electronic element is located within the mounting space.

In one embodiment, the driving mechanism further includes a detecting component disposed on the side of the circuit board facing the first cam. The detecting component is configured to detect the rotation of the first cam.

In one embodiment, the housing includes a mounting seat and a covering plate that covers the mounting seat. The first mounting surface is defined on the covering plate, the second mounting surface and the third mounting surface are defined on the mounting seat.

In one embodiment, the mounting seat includes a first plate portion adjacent to the first mounting surface, and a second plate portion away from the first mounting surface. The second mounting surface is defined on the second plate portion, the third mounting surface is defined on the first plate portion. The mounting seat is provided with a recess on the outer side of the first plate portion. The recess is configured to place the main body.

In one embodiment, the driving mechanism further includes a protective shield. The protective shield is disposed on the housing.

The present disclosure further provides a connecting assembly, which is applied to a water treatment apparatus. The water treatment apparatus is provided with a water softener valve and an upper water distributor. The water softener valve is provided with a mounting head, the connecting assembly includes a connecting seat.

Two ends of the connecting seat are cut-through, the connecting seat is plugged in the mounting head, the upper water distributor is plugged in the connecting seat and communicates with the valve cavity of the water softener valve.

In one embodiment, the outer wall of the upper water distributor is provided with a second flange extending circumferentially on the side of the first flange away from the water softener valve. The inner wall of the connecting seat is provided with a second clamping protrusion adapted to the second flange.

In one embodiment, the quantity of the first clamping protrusion is plural and are spaced apart along the circumferential direction; the quantity of the second clamping protrusion is plural and are spaced apart along the circumferential direction. The plural first clamping protrusions and second clamping protrusions are staggeredly arranged along the axial direction of the connecting seat.

In one embodiment, the mounting seat includes a first connecting cylinder and a second connecting cylinder adjacent sequentially along the axial direction thereof, the first connecting cylinder is plugged in the mounting head, the second connecting cylinder is exposed of the mounting head, the upper water distributor is plugged into the second connecting cylinder.

In one embodiment, the quantity of the connecting rib are plural, and the plural connecting ribs are spaced apart along the circumferential direction of the water-passing passage.

In one embodiment, the width of the connecting rib is increased from the end adjacent to the first connecting cylinder toward the end adjacent to the second connecting cylinder.

In one embodiment, the inner wall of the second connecting cylinder adjacent to the first connecting cylinder is provided with a protruding rib, the connecting rib is connected to the protruding rib.

In one embodiment, the first connecting cylinder, the second connecting cylinder and the connecting ribs are in an integrate structure.

The present disclosure further provides a water treatment apparatus, including a water softener valve, an upper water distributor and an ion exchange tank. The water softener valve is provided with a mounting head, the ion exchange tank is provided with an exchange port. The water treatment apparatus further includes a connecting assembly as described above. The connecting seat is plugged in the mounting head, the upper water distributor is plugged in the connecting seat, the mounting head is mounted at the exchange port to allow the inner cavity of the water softener valve to communicate with the inner cavity of the ion exchange tank.

The present disclosure further provides a connecting assembly, which is applied to a water treatment apparatus. The water treatment apparatus includes a water softener valve and a central tube, the water softener valve is provided with a mounting head. The connecting assembly includes a connecting seat, the connecting seat has two cut-through ends and is plugged in the mounting head, the central tube is plugged in the connecting seat to communicate with the inner cavity of the water softener valve.

In one embodiment, the outer peripheral wall of the first connecting cylinder is provided with a outer step, the inner peripheral wall is provided with an inner step corresponding to the outer step. The first annular cylinder abuts against the outer step, and the central tube abuts against the inner step.

In one embodiment, the outer peripheral wall of the first connecting cylinder located in the water-inlet passage is provided with a first sealing groove extending along the circumferential direction. The connecting assembly further includes a first sealing ring disposed in the first sealing groove.

In one embodiment, the inner wall of the first connecting cylinder away from the first annular cylinder is provided with a second sealing groove extending along the circumferential direction. The connecting assembly further includes a second sealing ring disposed in the second sealing groove.

In one embodiment, the first connecting cylinder includes a plugging cylinder and a socket cylinder adjacent sequentially along the axial direction thereof. The plugging cylinder is plugged in the first annular cylinder, the socket cylinder is connected to the outer wall of the plugging cylinder and annularly disposed on the periphery of the central tube. The socket cylinder and the central tube define an annular mounting space therebetween. The connecting assembly further includes a fixing member, the fixing member is disposed in the mounting space, to fix the second sealing ring.

In one embodiment, the fixing member has two cut-through ends and annularly disposed in the mounting space. The outer peripheral wall of the fixing member is provided with a clamping buckle, and the socket cylinder is provided with a clamping hole adapted to the clamping buckle.

In one embodiment, the mounting head further includes a second annular cylinder annularly disposed on the periphery of the first annular cylinder, the first annular cylinder and the second annular cylinder define a water-outlet passage therebetween. The connecting seat includes a second connecting cylinder adjacent to the socket cylinder along the circumferential direction thereof, the inner wall of the second connecting cylinder and the outer wall of the socket cylinder define an annular water-passing passage, the water-passing passage communicates with the water-outlet passage. The water treatment apparatus further includes an upper water distributor that is annularly disposed on the periphery of the central tube and communicates with the water-outlet passage, the upper water distributor is plugged in the second connecting cylinder.

In one embodiment, the connecting seat further includes a connecting rib that connects the inner wall of the second connecting cylinder and the outer wall of the socket cylinder, the quantity of the connecting rib is plural, and the plural connecting ribs are arranged along the circumferential direction of the water-passing passage.

The present disclosure also provides a water treatment apparatus. The water treatment apparatus includes a water softener valve, a central tube and an ion exchange tank. The water softener valve is provided with a mounting head, the ion exchange tank is provided with an exchange port. The water treatment apparatus further includes a connecting assembly as described above. The connecting seat is inserted in the mounting head, the central tube is inserted in the connecting base, and the mounting head is mounted on the exchange port, to allow the inner cavity of the water softener valve to communicate with the inner cavity of the ion exchange tank.

In the water softener valve according to the present disclosure, the mounting seat is provided with the sliding connection structure which is in a slidable fit with the first valve rod along the longitudinal direction and in a position-limiting cooperation with the first valve rod along the lateral direction, to form a double guiding structure. Therefore, when the rotational movement of the cam is converted into the linear movement of the first valve rod, the sliding connection structure can restrict the first valve rod from swinging in the lateral direction, and share the compressive stress of the first valve rod acting on the valve body in the lateral direction. On one hand, the wear of the sliding pair structure between the first valve rod and the valve body, and the risk of looseness are reduced; on the other hand, the movement of the first valve rod is smoother.

### BRIEF DESCRIPTION OF THE DRAWINGS

In order to more clearly illustrate the embodiments of the present disclosure, the drawings used in the embodiments will be briefly introduced below.

FIG. 1 is a structure view of a water softener valve of an embodiment according to the present disclosure;

FIG. 2 is a structure view of a valve body and a multi-way valve of an embodiment according to the present disclosure;

FIG. 3 is an partially exploded structure view of a water softener valve according to the present disclosure;

FIG. 4 is a structure view showing the cooperation of the first valve rod and the driving mechanism shown in FIG. 3;

FIG. 5 is a partially exploded structure view of the structure as shown in FIG. 4;

FIG. 6 is a structure view showing the cooperation of the cam and the first valve rod shown in FIG. 5;

FIG. 7 is a structure view showing the back side of the first mounting case shown in FIG. 5;

FIG. 8 is a structure view showing the cooperation of the sliding cooperation portion and the sliding connection portion as shown in FIG. 4;

FIG. 9 is a structure view of a water softener valve of an embodiment according to the present disclosure;

FIG. 10 is a exploded structure view of the water softener valve of an embodiment according to the present disclosure;

FIG. 11 is a side view of a water softener valve of an embodiment according to the present disclosure;

FIG. 12 is another side view of a water softener valve as shown in FIG. 11;

FIG. 13 is a structure view of a fixing member according to the present disclosure;

FIG. 14 is a side view of a fixing member according to the present disclosure;

FIG. 15 is a exploded structure view of the piston assembly of an embodiment according to the present disclosure;

FIG. 16 is a cross-sectional view of a water softener valve piston assembly of an embodiment according to the present disclosure;

FIG. 17 is a cross-sectional view of a water softener of an embodiment according to the present disclosure;

FIG. 18 is a partial enlarged view of A as shown in FIG. 17;

FIG. 19 is a exploded structure view of the piston rod sealing structure of an embodiment according to the present disclosure;

FIG. 20 is a cross-sectional view of the piston rod sealing structure of an embodiment according to the present disclosure;

FIG. 21 is a structure view of a water softener valve of an embodiment according to the present disclosure;

FIG. 22 is a structure view of a water softener valve of an embodiment according to the present disclosure;

FIG. 23 is a partially exploded structure view of the the water softener valve as shown in FIG. 22 with the driving mechanism removed;

FIG. 24 is a partially exploded structure view of the the water softener valve as shown in FIG. 22;

FIG. 25 is a structure view of the driving mechanism as shown in FIG. 25 with the shield removed;

FIG. 26 is a partially exploded structure view of the structure as shown in FIG. 25;

FIG. 27 is a structure view showing the cooperation of the first cam, the second cam and the driving wheel, the first valve rod and the second valve rod in FIG. 26;

FIG. 28 is a top view of the driving mechanism as shown in FIG. 25;

FIG. 29 is a cross-sectional view of the structure in FIG. 28 along line XI-XI;

FIG. 30 is a structure view of a connecting member of an embodiment according to the present disclosure;

FIG. 31 is a projection view of a connecting assembly of an embodiment according to the present disclosure;

FIG. 32 is a cross-sectional view of a connecting member of an embodiment according to the present disclosure;

FIG. 33 is a cross-sectional view of a connecting member of another embodiment according to the present disclosure;

FIG. 34 is a structure view of a water treatment apparatus of an embodiment according to the present disclosure;

FIG. 35 is a structure view of a water treatment apparatus of another embodiment according to the present disclosure;

FIG. 36 is a partial enlarged view of A as shown in FIG. 35;

FIG. 37 is a cross-sectional view of a water softener valve according to the present disclosure;

Embodiments of the present disclosure are further described in detail with reference to the accompanying drawings and the embodiments.

### DETAILED DESCRIPTION OF THE EMBODIMENTS

The technical solutions in the embodiments of the present disclosure are clearly and completely described in the following with reference to the accompanying drawings in the embodiments of the present disclosure. It will be appreciated that the described embodiments are merely part of the embodiments of the present disclosure, rather than all the embodiments.

It should be noted that, if there is a directional indication (such as up, down, left, right, front, back, . . . ) in the embodiment of the present disclosure, the directional indication is merely used to explain, in a certain posture (as shown in the drawing), relative positional relationship, movement and so on between parts. If the certain posture changes, the directional indication changes correspondingly.

The present disclosure provides a water softener valve.

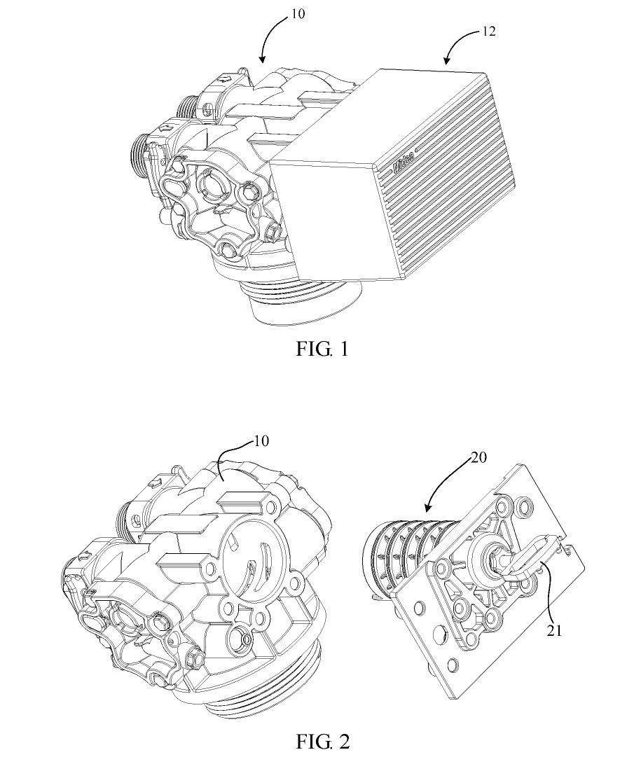

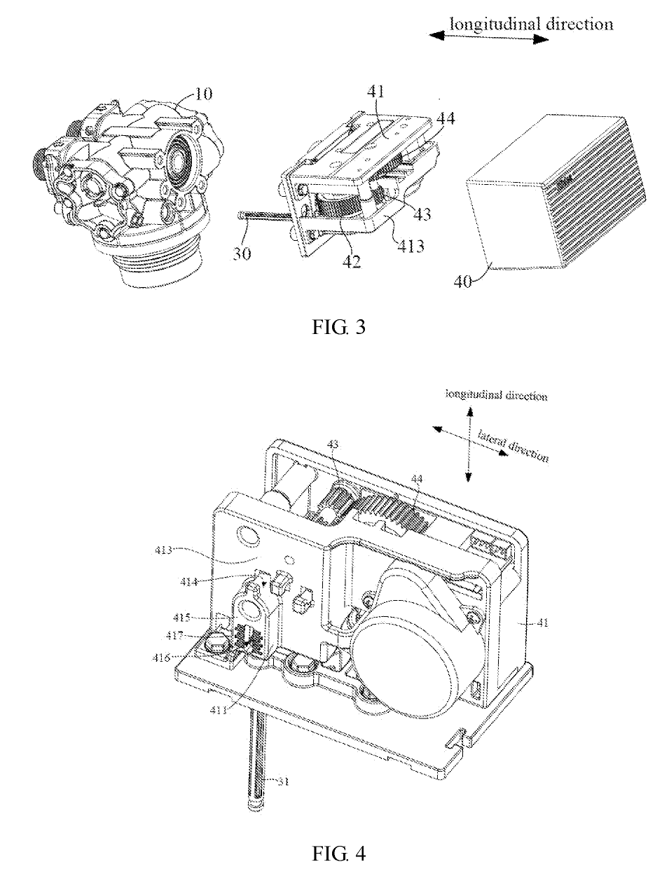

In some embodiments of the present disclosure, as shown in FIG. 1-4, the water softener valve includes a valve body 10, a multi-way valve 20, a saline solution suction and water injection valve 30 and a driving mechanism 40. The saline solution suction and water injection valve 30 includes a first valve rod 31, the driving mechanism 40 includes a mounting seat 41 and a cam 42. The end of the first valve rod 31 extending out of the valve body 10 is transmission cooperated with the cam 42. The mounting seat 41 is provided with a sliding connection structure 411. The outer end of the first valve rod 31 is sliding fit with the sliding connection structure 411 along the longitudinal direction, and the outer end of the first valve rod 31 is position-limiting cooperated with the sliding connection structure 411 along the lateral direction. The longitudinal direction coincides with the length direction of the first valve rod 31, the lateral direction is perpendicular to the longitudinal direction and the axial direction of the cam 42.

In some embodiments, the outer end of the first valve rod 31 is the end of the first valve rod 31 extending out of the valve body 10. The outer end of the first valve rod 31 is transmission cooperated with the cam 42. To realize this, for example, an eccentric annular groove is disposed on the cam 42, and a protrusion which is sliding fit with the annular groove is disposed on the first valve rod 31; or, an eccentric protrusion is disposed on the cam 42, and a strip groove which is sliding fit with the protrusion is disposed on the first valve rod 31. The multi-way valve 20 is configured to realize switching different water passages in the valve body 10. The saline solution suction and water injection valve 30 is configured to cooperate with the multi-way valve 20 to open or close water injection during the salt suction process or the water injection process of the water softener valve. Specifically, the end of the first valve rod 31 extending into the valve body 10 connects to a water injection piston. The first valve rod 31 linearly reciprocates to drive the water injection piston to stay at a water injection open position or a water injection closing position.

Similarly to the cooperation between the cam 42 and the first valve rod 31, the sliding connection structure 411 on the mounting seat 41 may be a groove, and the first valve rod 31 may cooperate with the groove directly, or cooperate with the groove by providing a protrusion; in contrast, if the sliding connection structure 411 is a protrusion, the first rod 31 may be provided with a groove which is cooperated with the protrusion.

It should be understood that, as the rotational movement of the cam 42 is converted into the linear movement of the first valve rod 31, in addition to the force that pulls the first valve rod 31 out of the valve body 10 or presses the first valve rod 31 into the valve body 10, a force that causes the first valve rod 31 to swing along the lateral direction is also generated. In the existing water softener valve, this swing force is directly transmitted to the sliding pair between the first valve rod 31 and the valve body 10. However, in the present disclosure, this swing force could be counteracted by the cooperation of the sliding connection structure 411 and the first valve rod 31 in the lateral direction, to allow the swing force transmitted to the cooperation portion of the first valve rod 31 and the valve body 10 to be greatly reduced.

In the water softener valve according to the present disclosure, the mounting seat 41 is provided with the sliding connection structure 411 which is in a slidable fit with the first valve rod 31 along the longitudinal direction and in a position-limiting cooperation with the first valve rod 31 along the lateral direction, to form a double guiding structure. Therefore, as the rotational movement of the cam 42 is converted into the linear movement of the first valve rod 31, the sliding connection structure 411 could restrict the first valve rod 31 from swinging in the lateral direction, and share the compressive stress of the first valve rod 31 acting on the valve body 10 along the lateral direction. On one hand, the risk of wear and looseness of the sliding pair structure between the first valve rod 31 and the valve body 10 is reduced, on the other hand, the movement of the first valve rod 31 is smoother.

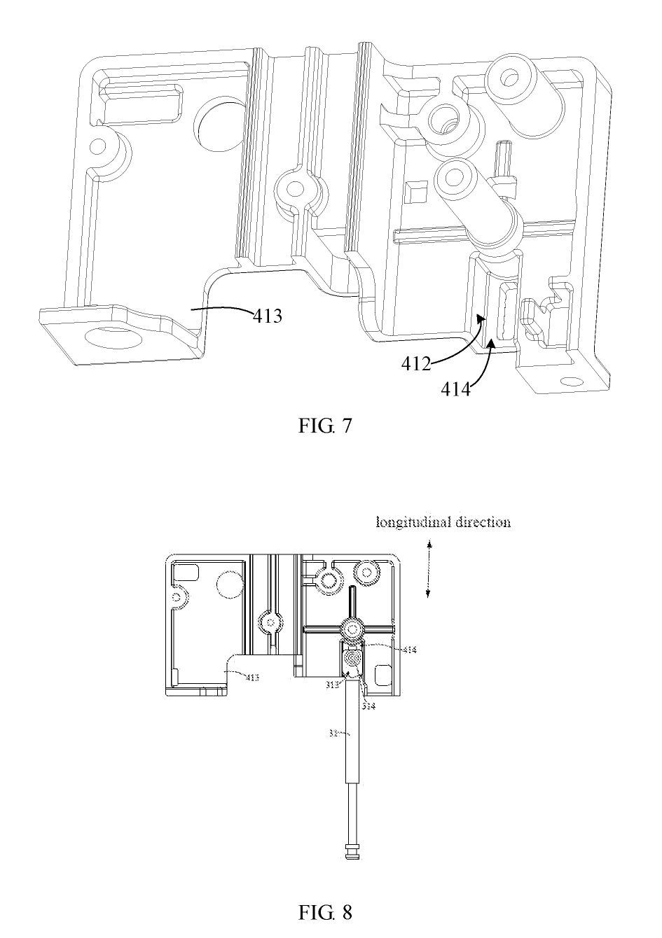

Further, as shown in FIGS. 7 and 8, the sliding connection structure 411 is provided with two guiding surfaces 412 opposite to each other in the lateral direction.

The outer end of the first valve rod 31 extends into and locates between the two guiding surfaces 412 and is sliding fit with the two guiding surfaces 412 along the longitudinal direction respectively. In this embodiment, the two guiding surfaces 412 are provided with a slideway therebetween. The first valve rod 31 may slide fit with the slideway via the outer peripheral surface thereof in a direct way, or may be provided with a sliding cooperation structure to cooperate with the slideway.

It should be noted that, if the two guiding surfaces cooperated with the first valve rod 31 face away from each other in the lateral direction, that is, if the sliding connection structure 411 is a protrusion, a slideway cooperated with the protrusion needs to be directly or indirectly opened on the first valve rod 31, and the slideway needs to extend a certain length in the longitudinal direction to satisfy the moving distance of the first valve rod 31. If the slideway is narrow, the thickness of the protrusion is correspondingly small and the protrusion is easily to be damaged; if the slideway is wide, the structural strength of the first valve rod 31 would be weakened, or the structure of the first valve rod 31 would be more complicated. Therefore, compared to this, the cooperation between the sliding connection structure 411 and the first valve rod 31 is simpler and more compact, the strength is higher.

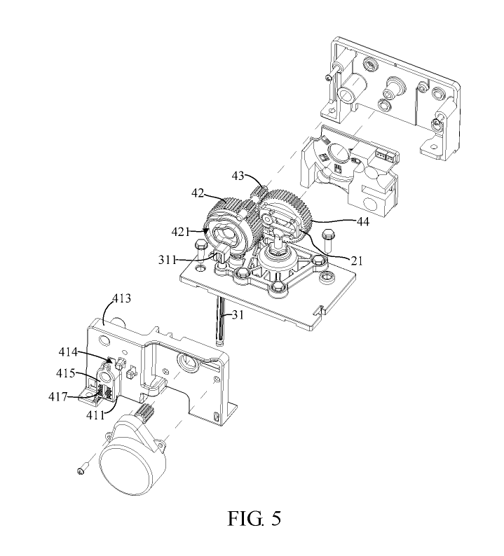

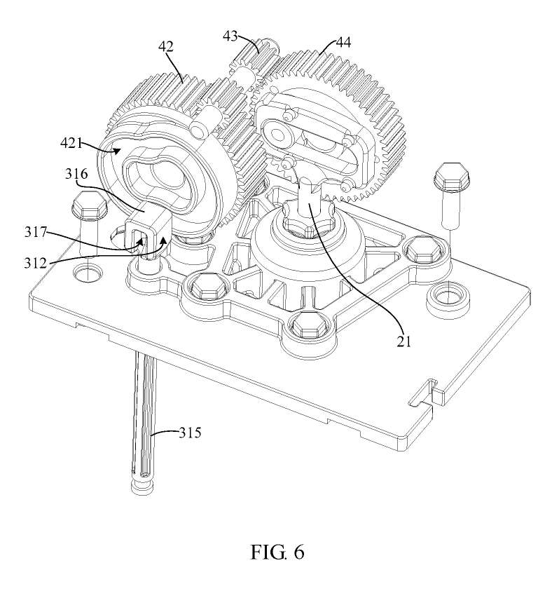

Further, as shown in FIGS. 5 and 6, the outer end of the first valve rod 31 is provided with a sliding cooperation portion 311 which is sliding fit with the sliding connection structure 411. The sliding cooperation portion 311 is provided with two sliding connection surfaces 312 which protrude from the outer peripheral surface of the first valve rod 31 and slide fit with the two guiding surfaces 412 respectively. In some embodiments, the area of the two sliding connection surfaces 312 is smaller than that of the two guiding surfaces 412, to reduce the sliding friction force, further reducing the hindrance to the movement of the first valve rod 31. The outer end of the first valve rod 31 is provided with the sliding cooperation portion 311, reducing the overall contact area of the first valve rod 31 and the two guiding surfaces 412, thereby reducing frictional resistance. And the effective contact area between the sliding cooperation portion 311 and the two guiding surfaces 412 is ensured, thereby the position-limiting cooperation stability of the sliding connection structure 411 and the sliding cooperation portion 311 is ensured.

Further, as shown in FIGS. 6 and 8, the sliding cooperation portion 311 is further provided with a transmission surface 313 which connects the two sliding connection surfaces 312 and faces the cam 42. The transmission surface 313 is provided with a transmission shaft 314, and the cam 42 is provided with a transmission groove 421 that is adapted to the transmission shaft 314. In some embodiments, the transmission groove 421 is an eccentric annular groove, and the transmission shaft 314 cooperates with the transmission groove 421 to convert the rotational movement of the cam 42 into a linear movement of the first valve rod 31 along the longitudinal direction. The transmission shaft 314 is disposed on the sliding cooperation portion 311 of the first valve rod 31, effectively utilizing the sliding cooperation portion 311, to allow the overall structure of the first valve rod 31 simpler and more compact. And for the first valve rod 31, the structure configured for the sliding cooperation is arranged adjacent to the structure for the position-limiting cooperation in the lateral direction, which could limit the swing of the first valve rod 31 in the lateral direction to the utmost extent. On one hand, the movement of the first valve rod 31 is more stable; on the other hand, the compressive stress transmitted to the cooperation portion of the first valve rod 31 and the valve body 10 is further reduced.

Further, as shown in FIGS. 4, 7 and 8, the mounting seat 41 includes a first mounting plate 413. The side of the first mounting plate 413 facing the cam 42 is recessed to form a sliding groove 414 extending along the longitudinal direction. The two guiding surfaces 412 are respectively located on the two opposite inner walls of the sliding groove 414, the sliding cooperation portion 311 slides fit with the sliding groove 414.

In some embodiments, the sliding groove 414 extends to the side of the first mounting plate 413 adjacent to the valve body 10, and the two guiding surfaces 412 are located on the two opposite inner walls of the sliding groove 414 in the lateral direction. It should be understood that, the extending length of the sliding groove 414 in the longitudinal direction should satisfy the extreme position that the outer end of the first valve rod 31 is farthest from the valve body 10. In some embodiments, the mounting seat 41 further includes a covering plate opposite to the first mounting plate 413. The first mounting plate 413 is configured to, together with the covering plate, define a first mounting cavity (not shown) for mounting the cam 42. The sliding groove 414 is directly opened on the first mounting plate 413, making the sliding connection structure 411 more compact and the production more convenient.

Further, as shown in FIG. 4, the sliding groove 414 includes a bottom wall 415 opposite to the cam 42. The bottom wall 415 is opened with an observation hole 416 extending along the longitudinal direction, and the bottom wall 415 is provided with an indication scale 417 on at least one side of the observation hole 416 in the lateral direction. In some embodiments, the observation hole 416 is configured for users to observe the real-time position of the sliding cooperation portion 311, to understand the actual position of the water injection piston in the valve body 10. And the indication scale 417 is configured to facilitate a more intuitive understanding of the actual position of the water injection piston in the valve body 10. The indication scale 417 is optionally disposed on the side of the bottom wall 415 facing away from the cam 42, or disposed on both sides of the observation hole 416 in the lateral direction, for an easier observation.

Further, the transmission surface 313 is flush with the side of the first valve rod 31 facing the cam 42 and adjacent to the cam 42, the sliding connection surface 312 extends away from the cam 42.

In some embodiments, in ideal state, the transmission surface 313 should be as close as possible to the cam 42 and remain flush with the side of the first valve rod 31 facing the cam 42, to allow the first valve rod 31 to be as close as possible to the cam 42 accordingly, thereby effectively reducing the transmission torque of the first valve rod 31 and the cam 42, to reduce power loss during transmission. When the first valve rod 31 is closer to the cam 42, since the sliding cooperation portion 311 needs to cooperate with the sliding groove 414 which is opened on the first mounting plate 413, if the first mounting plate 413 is also closer to the cam 42, the fixing structure on the first mounting plate 413 would hinder the rotation of the cam 42, therefore, the first mounting plate 413 should keep some distance from the cam 42. The sliding connection surface 312 needs to keep a sufficient contact area with the guiding surface 412, so the sliding connection surface 312 should face the first mounting plate 413. Specifically, the sliding connection surface 312 extends in a direction close to the sliding groove 414 and sticks out the side of the first valve rod 31 facing the first mounting plate 413, to effectively cooperate with the guiding surface 412.

Further, as shown in FIG. 6, the first valve rod 31 includes a rod portion 315, the sliding cooperation portion 311 includes a sliding block 316 arranged to be hollow and disposed at an end of the rod portion 315, the end of the rod portion 315 extends into the inner cavity of the sliding block 316 and connects to the sliding block 316. The side of the sliding block 316 facing the bottom wall 415 is opened a through hole 317 corresponding to the observation hole 416. In this embodiment, if the size of the sliding block 316 along the longitudinal direction is larger than that of the observation hole 416, when the movement range of the first valve rod 31 is too small, the specific position of the water injection piston cannot be accurately determined through the observation hole 416. The hollow sliding block 316 and the through hole 317 opened on the sliding block 316 enable users to observe the end of the rod portion 315 located in the sliding block 316, so that the position of the water injection piston determined according to the position of the end of the rod portion 315 is more real and effective.

Further, as shown in FIG. 6, the multi-way valve 20 includes a second valve rod 21, the driving mechanism 40 further includes a driving wheel 44 and a transmission wheel 43. The driving wheel 44 is transmission cooperated with the outer end of the second valve rod 21, the transmission wheel 43 is transmission cooperated with the driving wheel 44 and the cam 42, to allow the first valve rod 31 to move in conjunction with the second valve rod 21. In some embodiments, the driving wheel 44 is transmission cooperated with the second valve rod 21, to convert the rotational movement of the driving wheel 44 into the linear movement of the second valve rod 21; the driving wheel 44 moves in conjunction with the cam 42, thereby to allow the first valve rod 31 to move in conjunction with the second valve rod 21, which realizes a close cooperation between the multi-way valve 20 and the salt-water injection valve 30 in a corresponding position in the valve body 10 during the salting or annotating process of the water softener valve. In some embodiments, the driving mechanism 40 further includes a speed reducer group configured to provide power source, an output shaft of the speed reducer group is transmission connected to the driving wheel 44, and drives the cam 42 via the transmission wheel 43, to allow the driving wheel 44 and the cam 42 to share the same power source.

The present disclosure provides a water softener. The water softener includes a water softener valve, the specific structure of the water softener valve refers to the above embodiments. Since the water softener adopts all the technical solutions of the above embodiments, at least, the water softener obtains all the effects brought by the technical solutions of the above embodiments, which are to be detailed herein.

The present disclosure further provides a water softener valve.

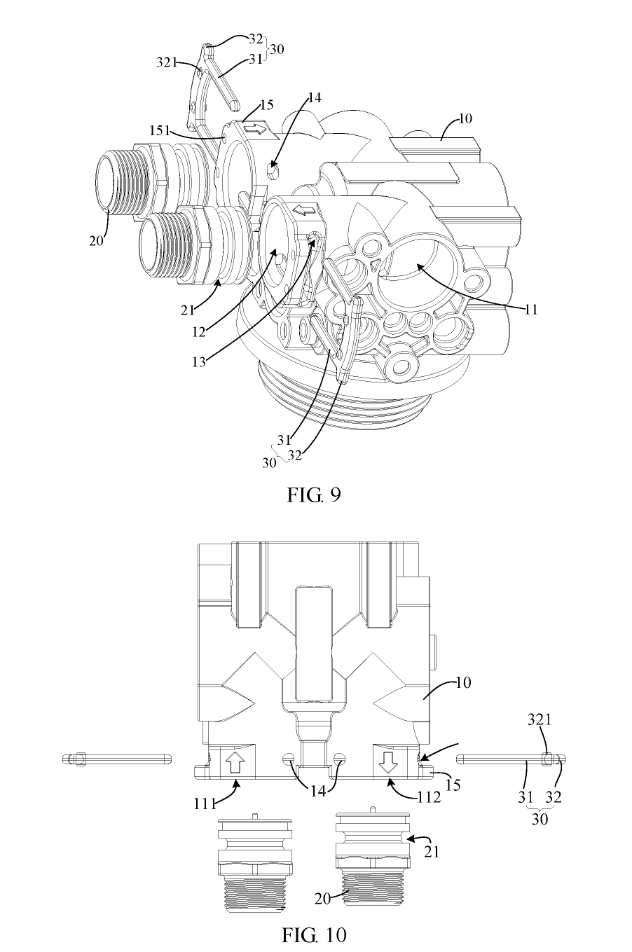

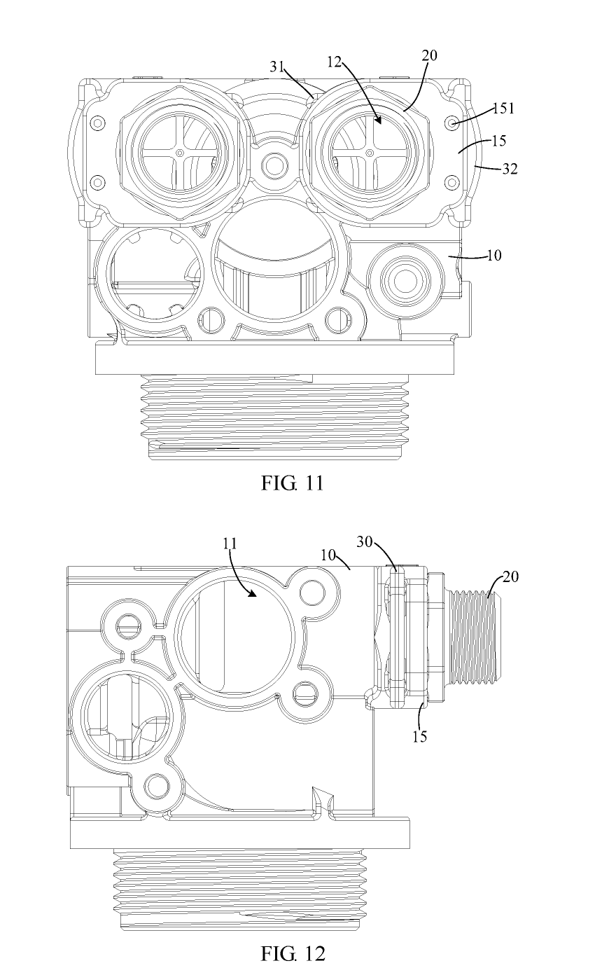

In some embodiments according to the present disclosure, as shown in FIGS. 9-14, the water softener valve includes:

a valve body 10, having a water-passing passage 11 and a water-passing port 12 communicating with one end of the water-passing passage 11, the valve body 10 being provided with a plug interface 13 which extends through the side wall of the water-passing passage 11 and is adjacent to the water-passing port 12;

a water-passing connector 20, being plugged in the water-passing port 12, the water-passing connector 20 having two cut-through ends and communicating with the water-passing passage 11; and

a fixing member 30, being plugged in the plug interface 13, and clamped at the portion of the water-passing connector 20 located in the water-passing passage 11, to at least limit the water-passing connector 20 in the axial direction of the water-passing connector 20.

In some embodiments, the water-passing passage 11 generally includes a water-inlet passage 111 and a water-outlet passage 112. The water-inlet passage 111 is configured allow the water untreated to flow into the water softener valve for ion exchange, and water-outlet passage 112 is configured allow the water softened to flow out the water softener valve for users to take. The water connector 20 is configured to connect to the external pipe and the water-passing passage 11, and the water connector 20 is plugged into the water-passing port 12, the water of the external pipe passes through the water-passing connector 20 and enters the water-passing passage 11 via the water-passing port 12. The plug interface 13 extends through the side wall of the water-passing passage 11, for the fixing member 30 to be plugged in. The fixing member 30 extends from the plug interface 13 into the water-passing passage 11 along a direction perpendicular to the axial direction of the water-passing passage 11 and is clamped with the water-passing connector 20, to allow the water-passing connector 20 to be limited at least along its axial direction.

It should be noted that, the water-passing connector 20 is sealingly cooperated with the side wall of the water-passing passage 11 at the side of the fixing member 30 away from the water-passing port 12. Specifically, the outer peripheral wall of the end of the water-passing connector 20 in the water-passing passage 11 is provided with a sealing groove extending circumferentially, and a sealing ring is disposed in the sealing groove, to prevent the joint of the water-passing passage 11 and the water-passing connector 20 from leaking water. The fixing member 30 is closer to the water-passing port 12 than the sealing ring and the sealing groove, to effectively seal the water-passing connector 20 and the water-passing passage 11. It should be understood that, the fixing member 30 may also limit the water-passing connector 20 along the circumferential direction, to avoid the rotation of the water-passing connector 20 to cause wear on the seal ring.

In the water softener valve according to the present disclosure, the side wall of the water-passing passage 11 is provided with the plug interface 13 adjacent to the water-passing port 12, and the fixing member 13 plugged in the plug interface 13 is in a position-limiting clamp connection with the water-passing connector 20 plugged in the water-passing port 12, so as to allow the water-passing connector 20 to be fixedly connected to the water-passing port 12. That is, the plug interface 13 together with the fixing member 30 realize the fixed connection between the water-passing connector 20 and the water-passing port 12 of the valve body 10, making the connection structure of the water-passing connector 20 and the valve body 10 simpler, and the production and processing more convenient.

Further, as shown in FIGS. 9-14, the fixing member 30 includes a pin 31, and the pin 31 extends into the water-passing passage 11 through the plug interface 13, and is clamped at the outer peripheral wall of the water-passing connector 20. In some embodiments, the pin 31 extends along a direction perpendicular to the axial direction of the water-passing passage 11, the plug interface 13 and the pin 31 are slidably cooperated. The pin 31 and the outer peripheral wall of the water-passing connector 20 may be clamped by a matching clamping structure. For example, a clamping hook is disposed on the pin 31, and a corresponding clamping ring is disposed on the outer peripheral wall of the water-passing connector 20; or, an embedded groove is provided on the pin 31, and a corresponding embedded block is disposed on the outer peripheral wall of the water-passing connector 20; or, the pin 31 itself is clamped with the clamping structure on the water-passing connector. As long as the pin 31 and the outer peripheral wall of the water-passing connector 20 is clamped. One end of the pin 31 may abut against the edge of the plug interface 13, to form a corresponding clamping force on the water-passing connector 20. The pin 31 is used to clamp the water-passing connector 20, making the structure of the fixing member 30 and the shape of the plug interface 13 simpler, which is convenient for production and processing of the water softener valve.

Further, as shown in FIGS. 9-14, the fixing member 30 further includes a connecting plate 32 located outside the plug interface 13. The quantity of the pin 31 is two, the two pins 31 are connected to one side of the connecting plate 32 and are spaced apart with each other. The two pins 31 are respectively clamped with the two portions of the outer peripheral wall of the water-passing connector 20 that face away from each other. In some embodiments, the thickness of the pin 31 is optionally the same as the thickness of the connecting plate 32. The connecting plate 32 extends in a direction perpendicular to the axial direction and abuts against the valve body 10. The quantity of the plug interface 13 corresponds to the quantity of the pins 31. The two pins 31 are respectively clamped with the two portions of the outer peripheral wall of the water-passing connector 20 that face away from each other, further improving the stability of the water-passing connector 20; and the water-passing connector 20 is clamped between the two pins 31, to limit the position of the water-passing connector 20 in the circumferential direction, so as to prevent the water-passing connector 20 from rotating.

Further, as shown in FIGS. 9 and 10, the outer peripheral wall of the water-passing connector 20 is provided with a clamping groove 21, the pin 31 is clamped in the clamping groove 21. In this embodiment, the clamping groove 21 extends along the circumferential direction of the water-passing connector 20, so that the water-passing connector 20 does not need to be rotated to position, to allow the pin 31 clamped in the clamping groove 21, which makes the clamping connection between the pin 31 and the water-passing connector 20 simpler and more convenient. The pin 31 is clamped in the clamping groove 21 itself, making the structure of the fixing member 30 simpler, and convenient for production. In some embodiments, the side of the connecting plate 32 connected to the pin 31 is disposed in a shape adapted to the portion abutting against the valve body 10, so as to make the overall structure of the water softener valve more compact.

Further, as shown in FIGS. 9-14, two ends of the connecting plate 32 respectively protrude from the outer sides of the two pins 31. In this embodiment, two ends of the connecting plate 32 respectively protrude from the outer sides of the two pins 31, to form a grip which is convenient for grasping the fixing member 30 during the process of mounting and dismounting the water-passing connector 20.

Further, as shown in FIGS. 9 and 10, the valve body 10 is further provided with a clamping connector 14 extending through the side wall of the water-passing passage 11. The clamping connector 14 is away from the plug interface 13. The free end of the pin 31 is clamped in the clamping connector 14. In some embodiments, the clamping connector 14 is located in a direction perpendicular to the axial direction of the plug interface 13, to make the plugging direction of the pin 31 more simple and reasonable. The free end of the pin 31 is clamped in the clamping connector 14, the fixed end of the pin 31 is clamped in the plug interface 13, which increases the contact area between the pin 31 and the valve body 10, so that the force of the water-passing connector 20 and the valve body 10 on the pin 31 is more dispersed, thereby improving the stability of the pin 31, and also making the clamping connection of the water-passing connector 20 more stable.

Further, as shown in FIGS. 9-12, the valve body 10 is further provided with a protrusion block 15 adjacent to the plug interface 13. The protrusion block 15 is provided with a clamping hole 151, and the connecting plate 32 is provided with a clamping protrusion 321 adapted to the clamping hole 151. In some embodiments, the protrusion block 15 is protruded between the plug interface 13 and the water-passing port 12, to effectively protect the fixing member 30 from being damaged during the use of the water softener valve. The protrusion block 15 extends along the length direction of the connecting plate 32 and opposite to the connecting plate 32. After the water-passing connector 20 is clamped in position by the fixing member 30, the clamping protrusion 321 on the connecting plate 32 is clamped in the clamping hole 151 on the protrusion block 15, to connect the fixing member 30 with the valve body 10, thereby, allowing the fixing member 30 to clamp the water-passing connector 20 more stable. In some embodiments, the quantity of the clamping protrusion 321 is two and spaced apart along the length direction of the connecting plate 32. The number and position of the clamping holes 151 correspond to the clamping protrusions 321, to improve the connection stability between the fixing member 30 and the valve body 10.

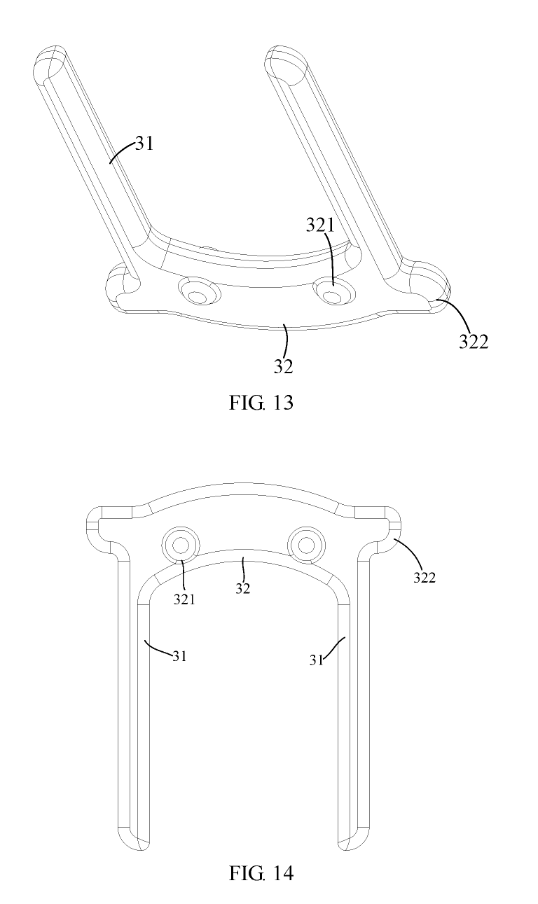

Further, as shown in FIGS. 13 and 14, the portions of the connecting plate 32 facing toward or facing away the protrusion block 15 are provided with the clamping protrusion 321. In some embodiments, the two opposite surfaces of the connecting plate 32 are both provided with the clamping protrusions 321, therefore, when the fixing member 30 is assembled, there is no need to flip the clamping protrusion 321 too much to align the clamping hole 151, making the assembly of the water softener valve more simple and convenient.

The present disclosure further provides a water treatment apparatus. The water treatment apparatus includes an ion exchange tank and a water softener valve, the specific structure of the water softener valve refers to the above embodiments Since the water treatment apparatus adopts all the technical solutions of the above embodiments, at least, the water treatment apparatus obtains all the effects brought by the technical solutions of the above embodiments, which are to be detailed herein. The water softener valve is mounted in the ion exchange tank, to allow the inner cavity of the valve body 10 to communicate with the inner cavity of the ion exchange tank.

The present disclosure further provides a water softener valve piston assembly.

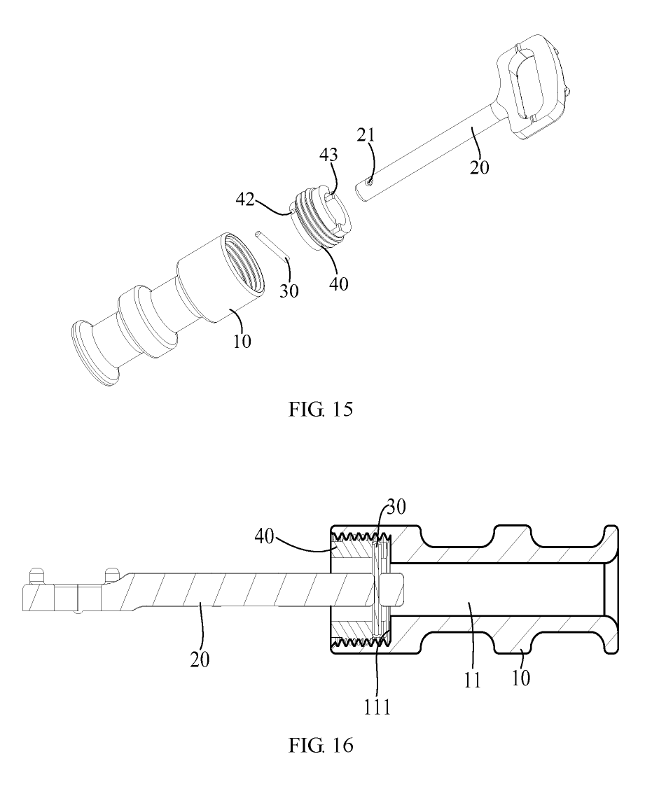

In some embodiments, as shown in FIGS. 15-16, the water softener valve piston assembly includes a piston body 10, a piston rod 20, a connecting member 30 and a fastening member 40. The piston body 10 is integrally disposed. The water softener valve piston assembly is provided with a water-passing passage extending along the telescopic direction of the piston rod 20 and two ends through the piston assembly. The connecting member 30 is disposed on the piston rod 20, the connecting member 30 and the piston rod 20 are position-limiting cooperated in the telescopic direction. The fastening member 40 cooperates with the piston body 10 to limit the connecting member 30 in the telescopic direction.

It should be noted that, the piston rod may be a rod structure other than the first valve rod in the above embodiments, and may also include the first valve rod in the above embodiments.

In some embodiments, the piston body 10 is integrated injection molding, and configured to realize switching different water passages of the multi-way valve in the water softener valve during telescopic movement. For example, the outer peripheral wall of the piston body 10 is provided with an annular water-passing groove extending along the circumferential direction of the piston body 10. At a position where a water passage is closed, the outer peripheral wall of the piston body 10 is completely blocked at the water-passing port of the water passage, so that the water fails to pass through. And at a position where a water passage is opened, the water-passing groove communicates with the water-passing port of the water passage, so that the water flows through the water-passing groove.

The piston rod 20 is configured to drive the piston body 10 to perform a telescopic movement. Specifically, the inner end of the piston rod 20, namely the end located in the water softener valve, connects to the piston body 10, and the outer end connects to the driving mechanism. The driving mechanism drives the piston rod 20 to move, further driving the piston body 10 to perform a telescopic movement, so that the automatic switching of the multi-way valve waterways is realized. The connecting member 30 and the piston rod 20 may be a fixed connection, or a detachable connection, as long as the position-limiting cooperation in the telescopic direction is satisfied, so as to allow the connecting member 30 to telescopically move together with the piston rod 20. The fastening member 40 cooperates with the piston body 10, and the fastening member 40 is provided with a limiting surface that abuts against the connecting member 30 in the telescopic direction, to limit the connecting member 30 together with the piston body 10. The water-passing passage is configured to communicate with the drainage passage of the water softener valve, to allow the wastewater generated by the water softener valve to be discharged through the water-passing passage, increasing utilization of the piston body 10.

In the water softener valve according to the present disclosure, the piston assembly and the piston body 10 are integrally arranged, and the fastening member 40 cooperates with the piston body 10 to limit the connection member 30 disposed on the piston rod 20. Since the connecting member 30 and the piston rod 20 are position-limiting cooperated in the telescopic direction, the fastening member 40 and the connecting member 30 together form a connecting structure between the piston rod 20 and the piston body 10, to allow the piston rod 20 to drive the piston body 10 to perform the telescopic movement. Compared to the prior art, the water softener valve piston assembly of the present disclosure has fewer parts and a simpler structure, so that the installation is simpler, the production and processing cost is lower.

Further, as shown in FIGS. 15-16, the connecting member 30 is detachably connected to the piston rod 20, and the connecting member 30 is disposed at the inner end of the piston rod 20. In some embodiments, the connecting member 30 is disposed at the rear end of the piston rod 20, to reduce the length of the piston rod 20, thereby reducing the occupation of the space and the loss of the power source of the driving mechanism. The connecting member 30 and the piston rod 20 are detachably connected, to facilitate the disassembly and assembly of the piston assembly of the water softener valve.

Further, as shown in FIGS. 15-16, the outer peripheral surface of the piston rod 20 is provided with an via hole 21, the connecting member 30 has a bar-like shape and passes through the via hole 21. In some embodiments, the via hole 21 is opened at the rear of the inner end of the piston rod 20, and penetrates through the outer peripheral wall of the piston rod 20, the connecting member 30 is disposed through the via hole 21, the two ends of the connecting member 30 both stick out from the outer peripheral wall of the piston rod 20, so as to realize the detachable connection between the piston rod 20 and the connecting member 30.

Further, as shown in FIGS. 15 and 16, the piston body 10 is provided with an inner cavity 11 extending along the telescopic direction of the piston rod 20 and having two cut-through ends, the inner wall of the inner cavity 11 is provided with a stepped surface 111, the fastening member 40 is annularly arranged and embedded in the inner cavity 11. The annular space formed between the inner annular surface of the fastening member 40 and the outer peripheral surface of the piston rod 20 communicates with the inner cavity 11, the connecting member 30 is clamped between the stepped surface 111 and the fastening member 40.

In some embodiments, the water-passing passage of the water softener valve piston assembly is disposed in the inner cavity 11 of the piston body 10, the inner wall of one end of the piston body 10 is recessed to form a sinking groove in the circumferential direction, and the stepped surface 111 is formed on the side wall of the sinking groove. The fastening member 40 is embedded in the sinking groove, the fastening member 40 is annularly disposed on the outer periphery of the piston rod 20. A limiting surface of the fastening member 40 faces the stepped surface 111. The inner end of the piston rod 20 extends in the inner cavity 11 of the piston body 10, to allow two ends of the connecting member 30 to be clamped between the stepped surface 111 and the limiting surface of the fastening member 40. It should be understood that, the length of the connecting member 30 should be smaller than the width of the inner cavity 11 of the piston body 10, and it should also satisfy that the inner wall of the sinking groove could limit the movement of the connecting member 30 along its length direction. The annular space formed between the inner annular surface of the fastening member 40 and the outer peripheral surface of the piston rod 20 communicates with the inner cavity 11 to form the water-passing passage.

When the driving assembly of the water softener valve drives the piston rod 20 to move into the water softener valve, the connecting member 30 moves with the piston rod 20, and a pushing force is transmitted from the connecting member 30 to the piston body 10 through the stepped surface 111 abutting against the connecting member 30, thereby pushing the piston body 10 to move in the same direction. In contrary, when the driving assembly of the water softener valve drives the piston rod 20 to move out from the water softener valve, a pulling force is transmitted to the fastening member 40 through the limiting surface of the fastening member 40, and the fastening member 40 cooperates with the piston body 10, so that the pulling force is transmitted to the piston body 10 through the fastening member 40, and drives the piston body 10 to move in the same direction.

Further, as shown in FIGS. 15 and 16, the fastening member 40 is detachably cooperated with the piston body 10. In some embodiments, the fastening member 40 has a certain length along the telescopic direction, to increase the cooperation area of the fastening member 40 and the piston body 10, so that the cooperation between the fastening member 40 and the piston body 10 is more stable. The fastening member 40 is detachably cooperated with the piston body 10, convenient for assembly and disassembly. Specifically, the outer peripheral surface of the fastening member 40 may be provided with an external thread, and the inner peripheral surface of the piston body 10 may be provided with an internal threaded, so as to form a threaded cooperation between the fastening member 40 and the piston body 10.

Further, as shown in FIG. 15, the end surface of the fastening member 40 facing away the stepped surface 111 is opened with a clamping notch 41. In some embodiments, the quantity of the clamping notch 41 is two, and the two clamping notches 41 are opposite in the circumferential direction of the fastening member 40. When assembling and disassembling the fastening member 40, the fastening member 40 is clamped in the clamping notch 41 by disassembly tools, making the disassembly of the fastening member 40 more convenient.

Further, as shown in FIG. 15, the end surface of the fastening member 40 facing the stepped surface 111 is opened with a clamping notch 42. The connecting member 30 is clamped in the limiting notch 42. In some embodiments, the quantity of the clamping notch 42 is two, and the two clamping notches 42 are opposite in the circumferential direction of the fastening member 40, two ends of the connecting member 30 are respectively clamped in the two clamping notches 42, to make the position-limiting connection of the fastening member 40 and the connecting member 30 more stable.

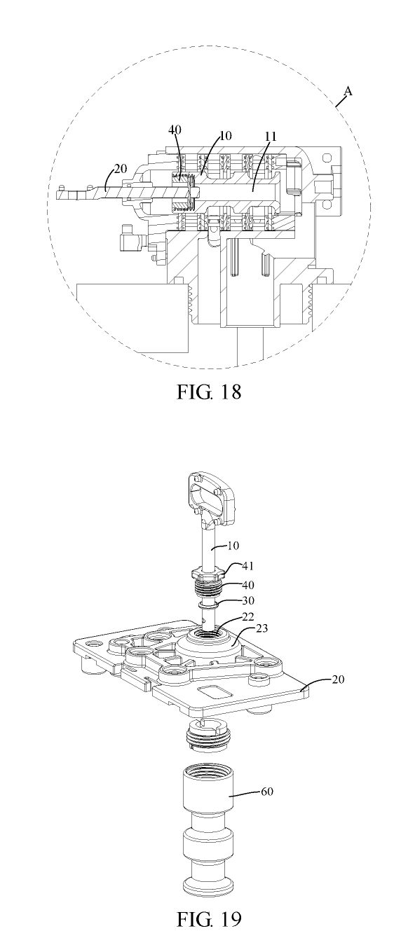

As shown in FIG. 18, the present disclosure further provides a water softener valve. The water softener valve includes a valve body and a water softener valve piston assembly, the specific structure of the water softener valve piston assembly referring to the above embodiments. Since the water softener valve adopts all the technical solutions of the above embodiments, at least, the water softener valve obtains all the effects brought by the technical solutions of the above embodiments, which are to be detailed herein.

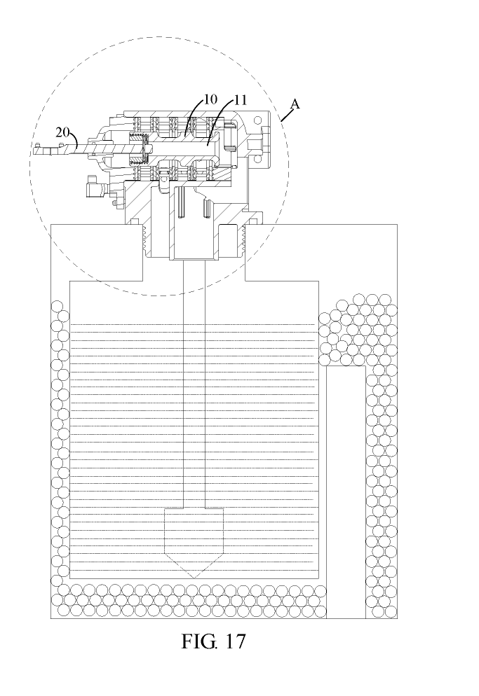

As shown in FIGS. 17 and 18, the present disclosure further provides a water softener. The water softener includes a water softener valve, the water softener valve includes a valve body and a water softener valve piston assembly. The specific structure of the water softener valve piston assembly refers to the above embodiments. Since the water softener adopts all the technical solutions of the above embodiments, at least, the water softener obtains all the effects brought by the technical solutions of the above embodiments, which are to be detailed herein.

The water softener further includes an ion exchange tank and a salt box. The ion exchange tank includes a tank body and a central tube disposed in the tank body. An ion exchange chamber is formed between the central tube and the inner wall of the tank body, the ion exchange chamber is received with ion exchange filter material. In one embodiment, the ion exchange filter material is soft water resin, so that the calcium ions and magnesium ions in the water to be treated may be conveniently replaced with sodium ions, and during the regeneration process, calcium ions and magnesium ions are replaced by discharge.

The present disclosure further provides a piston rod sealing structure of a water softener valve, which is applied to a water softener valve, the water softener valve is provided with a piston rod 10.

In some embodiments, as shown in FIGS. 19-21, the piston rod sealing structure includes:

a valve body 50, including a main body and an end cap 20, the main body having a valve cavity with one end open, the end cap 20 covering the open of the valve cavity, the end cap 20 being provided with a mounting hole 21 for the piston rod 10 to come in or out of the valve cavity;

a sealing ring 30, annually disposed at the edge of the mounting hole 21 and configured to be sealingly cooperated with the piston rod 10; and

a fixing member 40, fixedly connected to the end cap 20, to fix the sealing ring 30.

It should be noted that, the piston rod may be a rod structure other than the first valve rod in the above embodiments, and may also include the first valve rod in the above embodiments.

In some embodiments, the water softener valve further includes a piston body 60 located in the valve cavity. The inner end of the piston rod 10 connects to the piston body 60, to drive the piston body 60 to control the opening or closing of different water passages in the valve cavity by a telescopic movement of the piston rod 10. The piston rod 10 and the mounting hole 21 are sliding fit with each other, and sealingly cooperated by the sealing ring 30, to prevent water in the valve cavity from leaking through the mounting hole 21 during the telescopic movement of the piston rod 10. The fixing member 40 is configured for fix the sealing ring 30 to the edge of the mounting hole 21, and the fixing member 40 may fix the sealing ring 30 by pressing or clamping or the like. For example, one end of the fixing member 40 is fixedly connected to the end cap 20, the other end is pressed to the sealing ring 30, as long as the sealing ring 30 could be effectively fixed during the telescopic movement of the piston rod 10. The fixing member 40 and the end cap 20 may be in a detachable connection, or a non-detachable connection such as welding or integral arrangement, as long as the fixed connection is satisfied.

In the piston rod sealing structure of the water softener valve according to the present disclosure, the sealing ring 30 is fixed by the fixing member 40, so that the sealing ring 30 is more stably mounted on the end cap 20, and the cooperation with the sealing ring 30 is more stable, thereby enhancing the sealing performance of the water softener valve, improving the overall stability of the water softener valve.

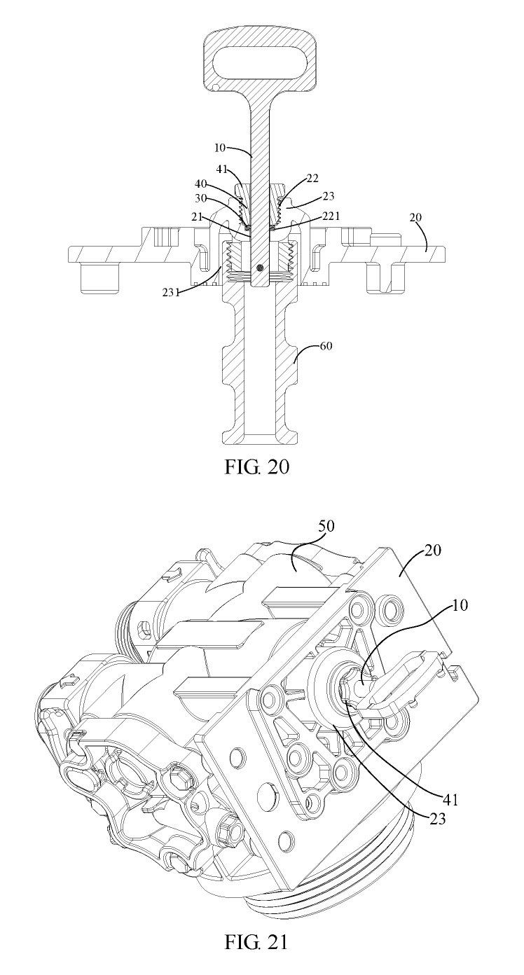

Further, as shown in FIG. 20, the end cap 20 is provided with a mounting groove 22, the mounting hole 21 is opened in the bottom wall of the mounting groove 22, the sealing ring 30 is disposed in the mounting groove 22, and the fixing member 40 is fixed to the mounting groove 22. In some embodiments, the shape of the mounting groove 22 is adapted to the shape of the mounting hole 21, to effectively utilize the bottom wall area of the mounting groove 22. The sealing ring 30 may be disposed on the bottom wall of the mounting groove 22, or disposed on the side wall of the mounting groove 22. Specifically, the side wall of the mounting groove 22 is provided with an annual groove, the sealing ring 30 is clamped in the annual groove, and the fixing member 40 clamps the sealing ring 30 in the annular groove. The fixing member 40 is disposed in the annular gap between the piston rod 10 and the side wall of the mounting groove 22. The fixing member 40 may extend along the circumferential direction of the piston rod 10, or include a plurality of fixing portions spaced apart along the annular gap, as long as the fixing member 40 fixes the sealing ring 30 in the mounting groove 22. The mounting groove 22 is opened on the end cap 20, the sealing ring 30 and the fixing member 40 are disposed in the mounting groove 22, to play a positioning role for the installation of the sealing ring 30, making the installation of the sealing ring 30 and the fixing member 40 more simple, and enhancing the sealing stability.

Further, as shown in FIG. 20, two ends of the fixing member 40 are cut-through, to press the sealing ring 30 to the bottom wall of the mounting groove 22 for the piston rod 10 to pass through. In this embodiment, the fixing member 40 extends along the circumferential direction of the piston rod 10 and slides fit with the piston rod 10. It should be noted that, the fixing member 40 is in a gap cooperation with the piston rod 10, to prevent resistance to the movement of the piston rod 10. The fixing member 40 having two ends through could increase the pressing area of the sealing ring 30, thereby enhancing the fixing effect on the sealing ring 30. In addition, the annular gap between the piston rod 10 and the side wall of the mounting groove 22 is also effectively utilized, to facilitate the fixed connection of the fixing member 40 to the mounting groove 22.

Further, as shown in FIG. 20, the bottom wall of the mounting groove 22 is recessed to form a sealing groove 221 extending along the circumferential direction of the mounting hole 21, and the sealing ring 30 is disposed in the sealing groove 221. In this embodiment, the bottom wall of the sealing groove 221 is adjacent to the edge of the mounting hole 21, and the sealing ring 30 is disposed in the sealing groove 221, which further facilitates the fixing member 40 pressing the sealing member 30, and improves the sealing stability of the sealing ring 30 in the lateral direction.

Further, as shown in FIG. 20, the outer surface of the end cap 20 is provided with a mounting post 23, and the mounting groove 22 is opened at the top of the mounting post 23. In some embodiments, the mounting post 23 may be a solid post or a hollow post, as long as the mounting groove 22 is allowed to be opened at the top of the mounting post 23. In one embodiment, the height of the mounting post 23 may be larger than the depth of the mounting groove 22. The mounting post 23 may be integrally formed with the end cap 20, or separately fixed to the end cap 20. The mounting post 23 could increase the depth of the mounting groove 22, so that the depth of the mounting groove 22 is not limited to the thickness of the end cap 20 itself, nor does it require space within the valve cavity. The mounting post 23 can also enhance the structural strength of the connecting position of the fixing member 40 and the end cap 20, and improve the mounting stability of the fixing member 40.

Further, the mounting post 23 is integrally formed with the end cap 20. In some embodiments, the mounting post 23 is integrally injection molded with the end cap 20, to reduce processing steps and production costs.

Further, as shown in FIG. 20, the side of the mounting post 23 facing away from the mounting groove 22 is hollow to form a positioning groove 231. The positioning groove 231 communicates with the mounting groove 22 through the mounting hole 21. In some embodiments, the inside of the mounting post 23 is hollow, the top wall and the side wall of the mounting post 23 are enclosed with the bottom wall and the side wall of the mounting groove 22 to form a positioning groove 231, the positioning groove 231 communicates with the valve cavity. The piston body 60 of the water softener valve may be disposed in the positioning groove 231 and be sliding fit with the side wall of the positioning groove 231, to improve the space utilization rate in the valve cavity, and play a positioning and guiding role in the movement of the piston body 60, which improves the stability of the expansion process of the piston rod 10 and the piston body 60, thereby improving the stability of the entire water softener valve.

Further, the fixing member 40 is detachably fixed to the mounting groove 22. In some embodiments, the fixing member 40 is detachably connected to the side wall of the mounting groove 22 via the outer peripheral wall thereof, to increase the contact area of the fixing member 40 with the mounting groove 22, making the mounting of the fixing member 40 more stable. The fixing member 40 and the mounting groove 22 are connected by means of thread, snap, and so on, as long as the detachable connection is satisfied. The fixing member 40 and the mounting groove 22 is in a detachable connection, convenient for the replacement of the sealing ring 30 and the timely correction when the sealing ring 30 is misaligned.

Further, as shown in FIG. 20, the fixing member 40 is threadedly cooperated with the mounting groove 22. In some embodiments, the outer peripheral wall of the fixing member 40 is provided with an external thread, and the inner wall of the mounting groove 22 is provided with an internal thread. After the internal thread is engaged with the external thread, the fixing member 40 could be spirally advanced axially toward the bottom wall of the mounting groove 22, and finally pressed to the sealing ring 30, which makes the mounting of the fixing member 40 simpler.

Further, as shown in FIGS. 19 and 20, the upper end of the fixing member 40 protrudes from the mounting groove 22 and extends outward along the radial direction to form a assembly knob 41. In some embodiments, the assembly knob 41 facilitates tightening the fixing member 40 during the assembly. In addition, after the fixing member 40 is mounted in position, the assembly knob 41 abuts against the top wall of the mounting post 23, to prevent the fixing member 40 from continuing to advance to cause excessive pressing on the sealing ring 30, thereby prolonging the service life of the sealing ring 30 and improving the overall sealing stability water softener valve. In some embodiments, the outer peripheral surface of the assembly knob 41 is provided with a plurality of switching protrusions spaced apart along the circumferential direction, and each two adjacent switching protrusions are connected by a smooth curved surface, to facilitate the grasping by hands or disassembly tools.

As shown in FIG. 21, the present disclosure further provides a water softener valve, the water softener valve includes a piston assembly. The piston assembly includes a piston rod 10 and a piston body 60. The water softener valve further includes a piston rod sealing structure, the specific structure of the piston rod sealing structure refers to the above embodiments. Since the water softener valve adopts all the technical solutions of the above embodiments, at least, the water softener valve obtains all the effects brought by the technical solutions of the above embodiments, which are to be detailed herein. The piston body 60 is located in the valve cavity, the piston rod 10 is sealingly cooperated with the sealing ring 30 and telescopically plugged in the mounting hole 21, the inner end of the piston rod 10 connects to the piston body 60.

The present disclosure further provides a water treatment apparatus, including an ion exchange tank and a water softener valve, the structure of the water softener valve refers to the above embodiments. Since the water treatment apparatus adopts all the technical solutions of the above embodiments, at least, the water treatment apparatus obtains all the effects brought by the technical solutions of the above embodiments, which are to be detailed herein. The water softener valve is mounted in the ion exchange tank to allow the valve cavity communicate with inner cavity of the ion exchange tank.

The present disclosure provides a water softener valve, which is applied to a water softener.

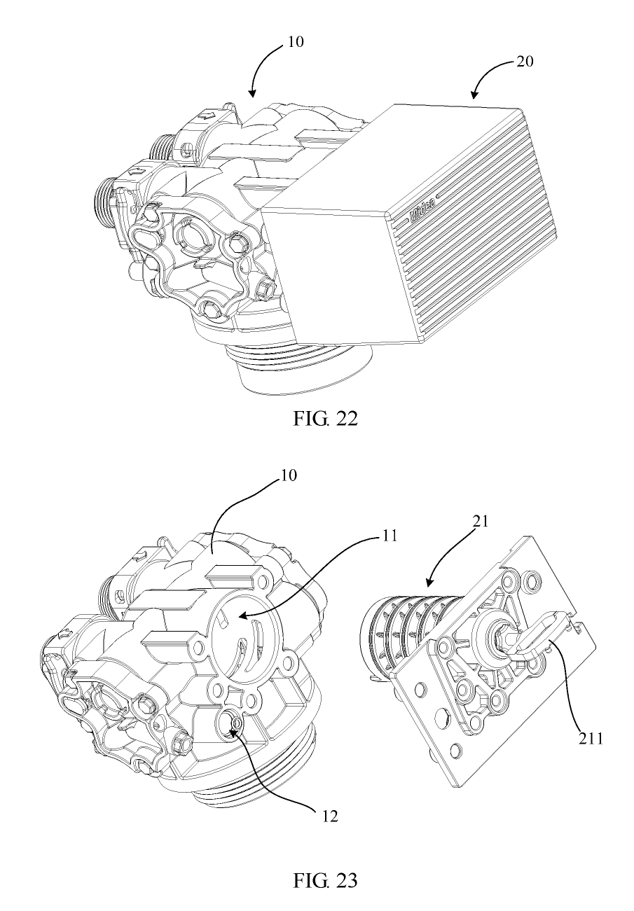

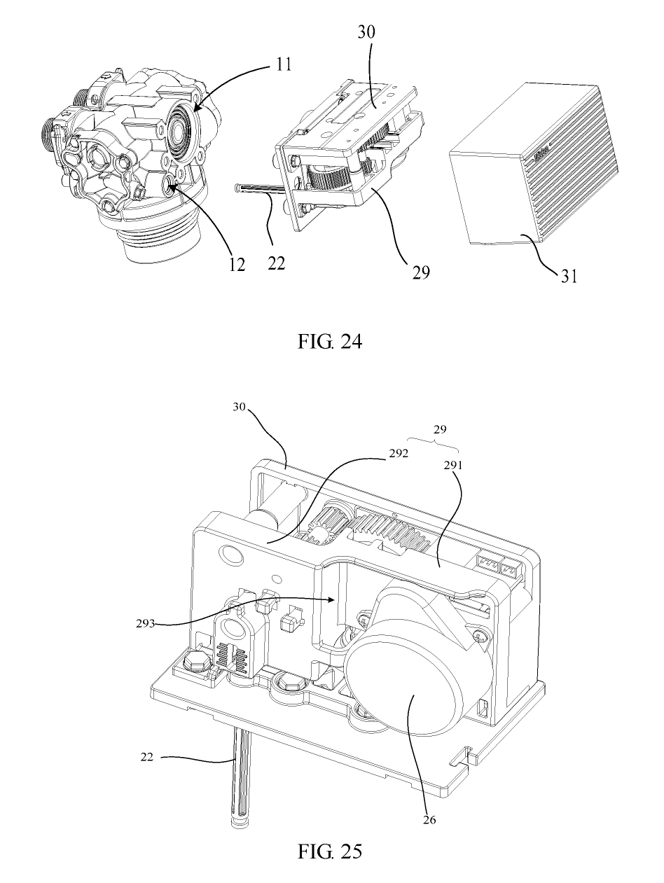

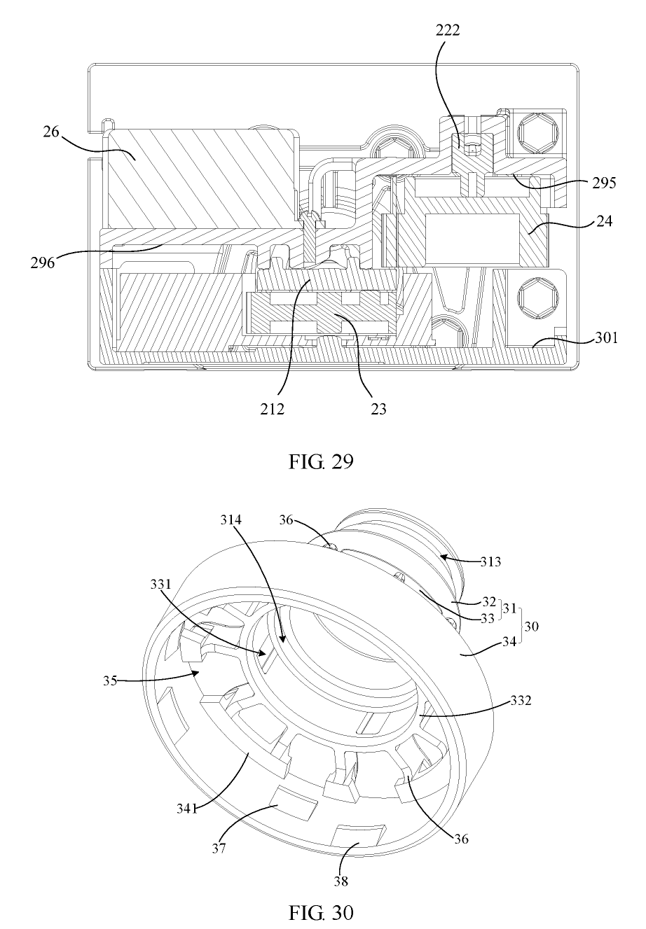

In some embodiments, as shown in FIGS. 22-29, the water softener valve includes a valve body 10, a multi-way valve 21, a saline solution suction and water injection valve 22 and a driving mechanism 20. The driving mechanism 20 is located on the outer side of the valve body 10. The valve body 10 is provided with a first open 11 and a second open 12. The multi-way valve 21 is partially plugged into the valve body 11 through the first open 11, the saline solution suction and water injection valve 22 is partially plugged into the valve body 11 through the second open 12.

The driving mechanism 20 includes a housing and a transmission shaft 25, the cam includes a first cam 23 and a second cam 24, the multi-way valve 21 is transmission cooperated with the first cam 23, the saline solution suction and water injection valve 22 is transmission cooperated with the second cam 24, the inner cavity of the housing is provided with a first mounting surface 301. Specifically, the multi-way valve 21 includes a first valve rod 211, the first valve rod 211 includes a first rod portion (not labeled) and a first transmission cooperation portion 212 disposed at one end of the first rod portion. The first transmission cooperation portion 212 is located outside the valve body 10, and the multi-way valve 21 is transmission cooperated with the first cam 23 via the first transmission cooperation portion 212. The saline solution suction and water injection valve 22 includes a second valve rod 221. The second valve rod 221 includes a second rod portion (not labeled) and a second transmission cooperation portion 222 disposed at one end of the second rod portion. The second transmission cooperation portion 222 is located outside the valve body 10, and the saline solution suction and water injection valve 22 is transmission cooperated with the second cam 24 via the second transmission cooperation portion 222.

The axes of the first cam 23, the second cam 24 and the transmission shaft 25 are arranged in parallel with each other, the outer peripheral surfaces of the first cam 23 and the second cam 24 are both provided with gear rack rows. The transmission shaft 25 is located between the first cam 23 and the second cam 24, the transmission shaft 25 is provided with a first tooth segment 251 engaged with the first cam 23, and a second tooth segment 252 engaged with the second cam 24. The first cam 23 is in a transmission cooperation with the second cam 24 via the transmission shaft 25. It should be understood that, if the first cam 23 is a driving wheel, the second cam 24 is a driven wheel; if the second cam 24 is a driving wheel, the first cam 23 is a driven wheel. In some embodiments, since the first cam 23 is in a transmission cooperation with the multi-way valve 21, the load of the first cam 23 is larger than the load of the second cam 24, so the first cam 23 is a driving wheel, and the second cam 24 is a driven wheel.

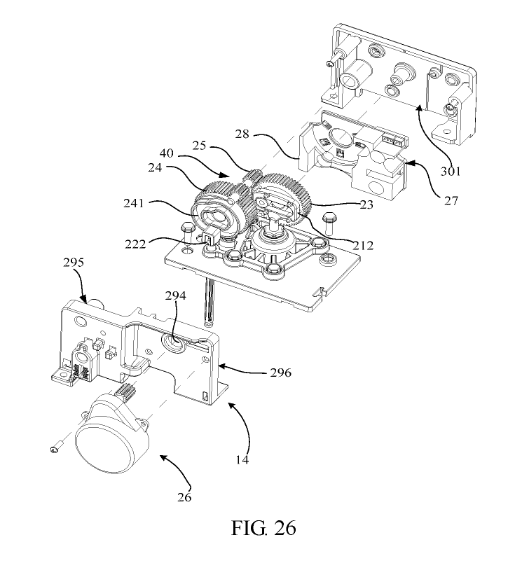

The first cam 23 and the second cam 24 are arranged in a double layer misalignment. The first cam 23 is adjacent to the first mounting surface 301. The second cam 24 and the first mounting surface 301 form a mounting space 40 therebetween. The mounting space 40 is configured to accommodate other components of the driving mechanism. For example, as shown in FIG. 26, the driving mechanism 20 further includes a circuit board 27 and an electronic component 28 disposed on the circuit board 27. The circuit board 27 is located between the first cam 23 and the first mounting surface 301, the electronic component 28 is located within the mounting space 40. Since the mounting space 40 is formed between the second cam 24 and the first mounting surface 301, the electronic component 28 is located within the mounting space 40, the overall structure of the water softener valve is more compact, and takes up less space.

In the present disclosure, the transmission shaft 25 is provided, the first tooth segment 251 of the transmission shaft 25 engages with the first cam 23 of the water softener valve, and the second tooth segment 252 engages with the second cam 24 of the water softener valve. The inner cavity of the housing of the water softener valve is provided with a first mounting surface 301. The first cam 23 is adjacent to the first mounting surface 301. The mounting space 40 is formed between the second cam 24 and the first mounting surface 301. The mounting space 40 is configured to accommodate other components of the driving mechanism 20, therefore, the water softener valve has a more compact overall structure and takes up less space.

Further, as shown in FIGS. 26, 28 and 29, the inner cavity of the housing is provided with a second mounting surface 295 opposite to the first mounting surface 301, the outer end of the valve rod of the saline solution suction and water injection valve 22 is located between the second mounting surface 295 and the second cam 24. The inner cavity of the housing is provided with a third mounting surface 296 opposite to the first mounting surface 301, the third mounting surface 296 is closer to the first mounting surface 301 than the second mounting surface 295, the outer end of the valve rod of the multi-way valve 21 is located between the third mounting surface 296 and the first cam 23. The outer end of the valve rod of the saline solution suction and water injection valve 22 is located between the second mounting surface 295 and the second cam 24, and the outer end of the valve rod of the multi-way valve 21 is located on the third mounting surface 296 and the first cam 23, The reasonable arrangement of the positions of the outer end of the valve rod of the multi-way valve 21 and the outer end of the valve rod of the saline solution suction and water injection valve 22 in the driving mechanism 20, making the overall structure of the driving mechanism 20 of the water softener valve more compact, and freeing up the mounting space 40 for accommodation of other components of the drive mechanism 20.

Further, as shown in FIGS. 25 and 26, the driving mechanism 20 further includes a speed reductor group 26 for driving the first cam 23. The housing is opened with an via hole 294 penetrating through the third mounting surface 296. The speed reductor group 26 includes a main body and an output shaft, the main body is located outside the housing, and the output shaft passes through the via hole 294 and engages with the gear rack row on the outer peripheral surface of the first cam 23.

Specifically, as shown in FIGS. 26, 28 and 29, the housing includes a mounting seat 29 and a covering plate 30 that covers the mounting seat 29. The first cam 23, the second cam 24, and the transmission shaft 25 are all sandwiched between the mounting seat 29 and the covering plate 30. The first mounting surface 301 is formed on the covering plate 30, the second mounting surface 295 and the third mounting surface 296 are formed on the mounting seat 29. The covering plate 30 and the mounting seat 29 are functioned to fix and protect the first cam 23, the second cam 24 and the transmission shaft 25. The mounting seat 29 includes a first plate portion 291 adjacent to the first mounting surface 301, and a second plate portion 292 away from the first mounting surface 301. The second mounting surface 295 is formed on the second plate portion 292, the third mounting surface 296 is formed on the first plate portion 291. The mounting seat 29 is provided with a recess 293 on the outer side of the first plate portion 291, which is configured to place the main body of the speed reductor group 26. Since the recess 293 is provided for the main body of the speed reductor group 26 to be placed in, the internal space of the drive mechanism 20 is saved, and the structure of the water softener valve is more compact.

Further, the driving mechanism further includes a detecting component disposed on the side of the circuit board facing the first cam. The detecting component is configured to detect the rotation of the first cam, so that the rotational state of the first cam, such as the rotational speed of the first cam, the moving position, and so on, can be detected.

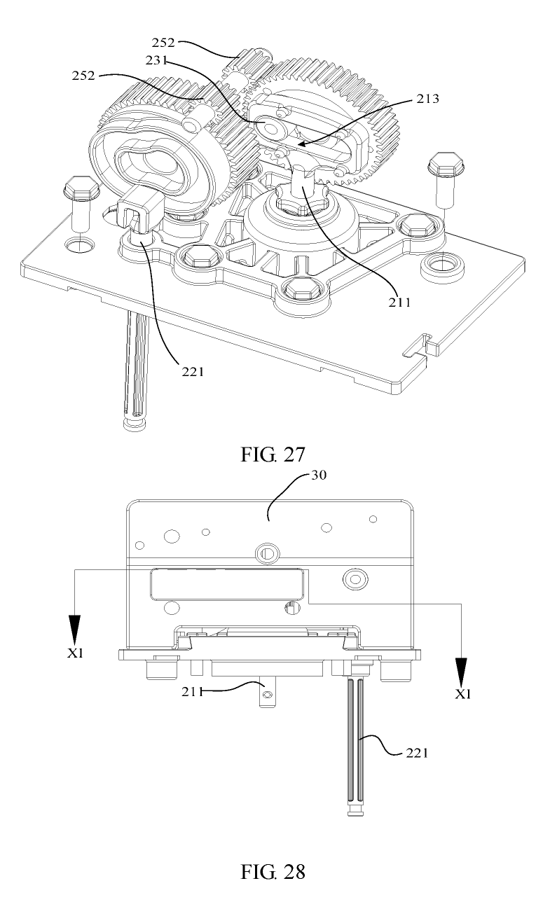

Specifically, as shown in FIGS. 26 and 27, the first transmission cooperation portion 212 protrudes from the peripheral surface of the first rod portion in a first direction. The first transmission cooperation portion 212 is provided with a first sliding groove 213 extending along the first direction. The first cam 23 is provided with an eccentric shaft 231 adapted to the first sliding groove 213. The first direction is perpendicular to the length direction of the first valve rod 211 and the axial direction of the first rod 23. The side of the first rod portion facing the first cam 23 is flush with the side of the first transmission cooperation portion 212 facing the first cam 23. The side of the first transmission cooperation portion 212 facing the first cam 23 is in a gap cooperation with the first cam 23, to prevent the first transmission cooperation portion 212 from rubbing against the first cam 23, thereby avoiding interference with the operation of the first cam 23.

The second transmission portion 222 is provided with a protrusion shaft (not shown) along the axial direction of the second cam 24 and facing toward the second cam 24, the second cam 24 is provided with a second sliding groove 241 adapted to the protrusion shaft, the second sliding groove 241 extends along a second direction. The second direction is perpendicular to the length direction of the second valve rod 221 and the axial direction of the second cam 24. The length of the protrusion shaft is larger than the depth of the second sliding groove 241. The side of the second transmission cooperation portion 222 facing the second cam 24 is in a gap cooperation with the second cam 24, to prevent the second transmission cooperation portion 222 from rubbing against the second cam 24, thereby avoiding interference with the operation of the second cam 24.

Further, the driving mechanism 20 further includes a protective shield 31 which is disposed on the housing. The protective shield 31 is functioned to avoid users being injured by the water softener valve when using the water softener.

The present disclosure further provides a water softener, the water softener includes a water softener main body and a water softener valve, the specific structure of the water softener valve refers to the above embodiments. Since the water softener adopts all the technical solutions of the above embodiments, at least, the water softener obtains all the effects brought by the technical solutions of the above embodiments, which are to be detailed herein.

The present disclosure further provides a connecting assembly, which is applied to a water treatment apparatus. The water treatment apparatus includes a water softener valve 10 and a central tube 20, the water softener valve 10 is provided with a mounting head 11.

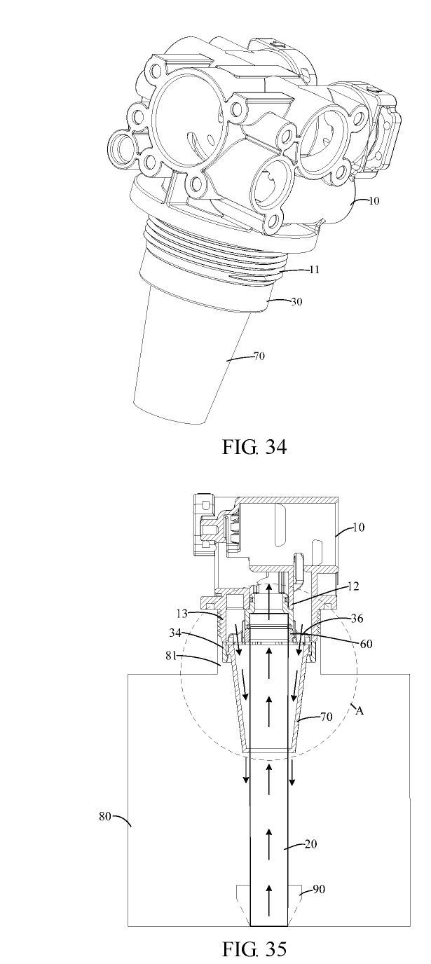

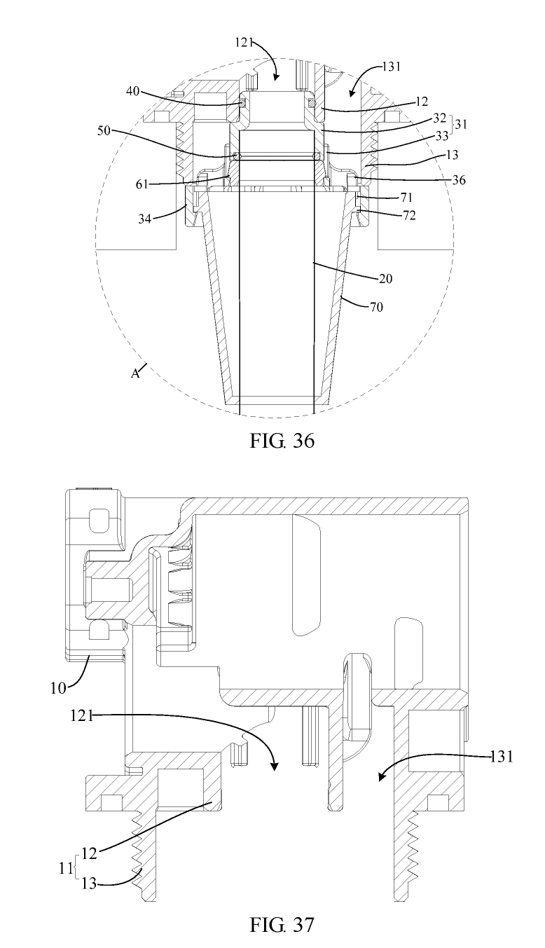

In some embodiments, as shown in FIGS. 30-37, the connecting assembly includes a connecting seat 30. Two ends of the connecting seat 30 are cut-through, and the connecting seat 30 is plugged in the mounting head 11, the central tube 20 is plugged in the connecting seat 30 and communicates with the valve cavity of the water softener valve 10.

In some embodiments, the water treatment apparatus further includes an ion exchange tank 80 and a salt box. The ion exchange tank 80 is provided with an exchange port 81, the inner cavity of the ion exchange tank 80 is filled with an ion exchange filter, such as a softening resin. In the process of the softened water production, the ion exchange filter in the ion exchange tank 80 replaces the calcium ions and magnesium ions in the raw water into sodium ions to generate the softened water; and in the process of water regeneration, the calcium ions and magnesium ions in the ion exchange tank 80 are replaced by sodium ions in the salt tank, so as to realize recycling. The exchange port 81 of the ion exchange tank 80 is generally disposed upward, and the ion exchange filter is located at the bottom of the ion exchange tank 80. The mounting head 11 of the water softener valve 10 is mounted downward to the exchange port 81 of the ion exchange tank 80, to allow the valve cavity of the water softener valve 10 to communicate with the inner cavity of the ion exchange tank 80. The water softener valve 10 further includes a valve core assembly located in the valve cavity thereof, for guiding water from an external pipeline into the valve cavity to the ion exchange tank 80 for working conditions, such as softened water production, salt suction forward washing, salt suction backwashing and so on. After being softened by the ion exchange of the ion exchange tank 80, the water flows back to the valve cavity of the water softener valve 10, and then flows out of the valve cavity for users to take.

The water-inlet passage 121 and the water-outlet passage 131 are formed inside the mounting head 11. The water in the valve cavity flows out from the water-outlet passage 131 to the ion exchange tank 80 for ion exchange, and flows back to the water softener valve from the ion exchange tank 80 through the water-inlet passage 121, then flows out of the valve cavity for users to take. It should be understood that, the water-inlet passage 121 and the water-outlet passage 131 are isolated from each other, to prevent the raw water and the softened water from flowing into each other when entering or leaving the water softener valve 10. In some embodiments, the water-outlet passage 131 is annularly disposed on the periphery of the water-inlet passage 121, the central tube 20 is configured to connect the water-inlet passage 121 and the ion exchange tank 80, to allow the softened water to flow to the water-inlet passage 121 from the ion exchange tank 80. And the central tube 20 is also configured to isolate the water-inlet passage 121 from the water-outlet passage 131. The raw water flows from the water-outlet passage 131 through the periphery of the central tube 20 into the ion exchange tank, and the softened water flows through the lumen of the central tube 20 to the water-inlet passage 121.

The connecting member includes a connecting seat 30 having two cut-through ends. The connecting seat 30 may be in the shape of a straight cylinder, or a stepped cylinder, as long as the connecting seat 30 could be plugged in the mounting head 11 and at least communicate with the water-inlet passage 121. The central tube 20 is plugged in the mounting seat 30, and connects to the water-inlet passage 121 by the connecting seat 30. The connecting seat 30 is fixedly plugged in the mounting head 11, the central tube 20 is fixedly plugged in the connecting seat 33. Therefore, the central tube 20 and the mounting head 11 could be relatively fixed without direct contact, that is, a structure for fixing the central tube 20 is not required to be formed on the mounting head 11, making the overall structure of the water softener valve 10 simpler. The mounting head 11 may abut against the connecting seat 30 via a stepped structure. For example, the connecting seat 30 has a stepped structure, the upper stepped surface of the stepped structure abuts against the mounting head 11, the lower stepped surface of the stepped structure abuts against the central tube 20, and the bottom end of the central tube 20 abuts against the bottom of the ion exchange tank 80, thereby realizing the fixing of the connecting seat 30.

During the assembly of the central tube 20 and the water softener valve 10, the connecting seat 30 allows a simple and convenient operation, thereby improving the overall assembly efficiency of the water treatment apparatus. In addition, if during assembly, the central tube 20 and the mounting head 11 are abnormally misaligned, since the connecting rod 30 between the central tube 20 and the mounting head 11 is subjected to the force due to the assembly displacement, therefore, it's easier to disassemble the abnormally assembled central tube 20 and the water softener valve 10, and no damage would be caused to the central tube 20 and the water softener valve 10, that is, the water softener valve 10 would not be scrapped directly, just replacing the connecting seat 30 would be fine. This reduces the risk of damage to the water softener valve 10 during assembly, thereby reducing the proportion of defective products, and the production cost caused by the defective products.

In the present disclosure, the connecting assembly connects to the water softener valve 10 and the central tube 20 via the connecting seat 30, which allows the water softener valve 10 to connect to the central tube 20 without a secondary processing, simplifying the overall structure of the water softener valve 10. In addition, the connecting assembly facilitates the connection between the water softener valve 10 and the central tube 20, thereby improving the assembly efficiency of the water treatment apparatus.

Further, as shown in FIGS. 30-37, the mounting head 11 includes a first annular cylinder 12. The first annular cylinder 12 defines a water-inlet passage 121. The connecting seat 30 includes a first connecting cylinder 31 which is plugged into the first annular cylinder 12, and the central tube 20 is plugged into the first connecting cylinder 31, to communicate with the water-inlet passage 121. In this embodiment, the central tube 20 communicates with the water-inlet passage 121 through the first connecting cylinder 31, so that the first annular cylinder 12 could be easily and conveniently fixed to the central tube 20 without being machined into a structure for a fixed connection with the central tube 20. In some embodiments, the outer wall of the first connecting cylinder 31 is sealingly cooperated with the inner wall of the first annular cylinder 12, the outer wall of the central tube 20 is sealingly cooperated with the inner wall of the first annular cylinder 12, to seal the central tube 20 with the water-inlet passage 121, thereby preventing softened water loss or raw water from flowing into the water-inlet passage 121.

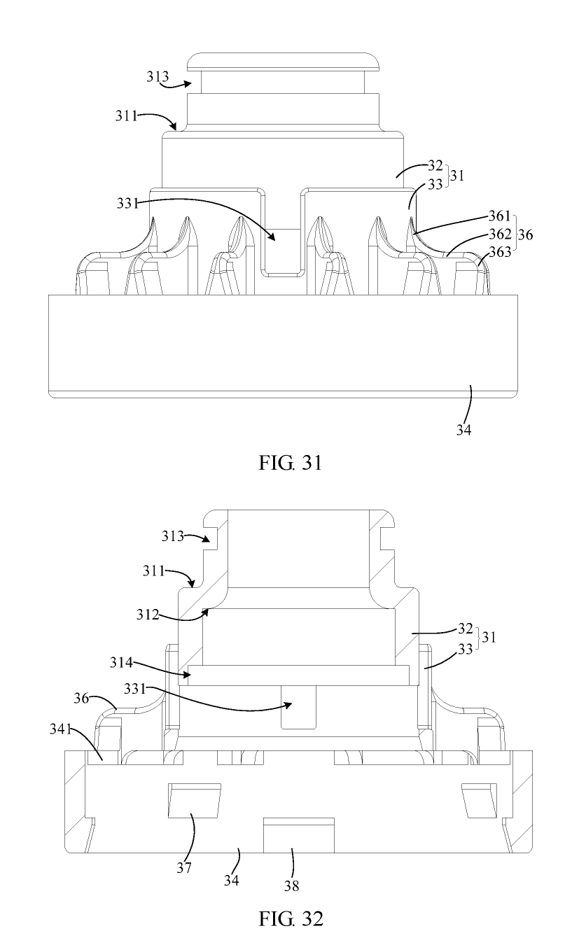

Further, as shown in FIGS. 31-36, the outer peripheral wall of the first connecting cylinder 31 is provided with an outer step 311, the inner peripheral wall is provided with an inner step 312 corresponding to the outer step 311. The first annular cylinder 12 abuts against the outer step 311, and the central tube 20 abuts against the inner step 312. In some embodiments, the portion of the first connecting cylinder 31 located in the water-passing passage and the portion exposed of the water-passing passage form an outer step 311 and an inner step 312. The stepped surface of the outer step 311 faces upward, and the lower end surface of the first annular cylinder 12 abuts against the stepped surface of the outer step 311; the stepped surface of the inner step 312 faces downward, and the upper end surface of the central tube 20 abuts against the stepped surface of the inner step 312. Thereby, the positioning abutment of the first annular cylinder 12 and the first connecting cylinder 31, as well as the central tube 20 and the first connecting cylinder 31, are respectively realized, making the mounting of the first connecting cylinder 31 and the first annular cylinder 12 as well as the central tube 20 simpler and more convenient.

Further, as shown in FIGS. 30-36, the outer peripheral wall of the first connecting cylinder 31 located in the water-inlet passage 121 is provided with a first sealing groove 313 extending circumferentially, and the connecting assembly further includes a first sealing ring 40 disposed in the first sealing groove 313. In this embodiment, the first sealing groove 313 is opened on the outer peripheral wall of the first connecting cylinder 31, and the first sealing ring 40 is disposed in the first sealing groove 313, so that the first annular cylinder 12 is not required to be machined to realize the sealing cooperation between the first connecting cylinder 31 with the first annular cylinder 12. When the connecting seat 30 is assembled, the first sealing ring 40 is plugged in the first annular cylinder 12 after being sleeved in the first sealing groove 313, thereby improving the sealing performance of the connecting component, thereby improving the overall water treatment equipment. Sealing performance.

Further, as shown in FIGS. 30-36, the outer peripheral wall of the first connecting cylinder 31 away from the first connecting the central tube 20 is abutted with the positioning of the first annular cylinder 12 is provided with a second sealing groove 314 extending circumferentially, and the connecting assembly further includes a second sealing ring 50 disposed in the second sealing groove 314. In this embodiment, the second sealing groove 314 is opened on the inner peripheral wall of the first connecting cylinder 31, and the second sealing ring 50 is disposed in the second sealing groove 314, so that the central tube 20 is not required to be machined to realize the sealing cooperation between the first connecting cylinder 31 with the central tube 20. Thereby, the sealing communication between the central pipe 20 and the water passage is realized, and the sealing performance of the connecting assembly is improved, all in all, the overall sealing performance of the water treatment apparatus is improved.

Further, as shown in FIGS. 30-36, the first connecting cylinder 31 includes a plugging cylinder 32 and a socket cylinder 33 which are adjacent sequentially along the axial direction thereof. The plugging cylinder 32 is plugged in the first annular cylinder 12, and the socket cylinder 33 is connected to the outer wall of the plugging cylinder 32 and annularly disposed on the outer periphery of the central tube 20, the socket cylinder 33 and the central tube 20 form an annular mounting space therebetween. The connecting assembly further includes a fixing member 60 disposed in the mounting space, to fix the second sealing ring 50.

In this embodiment, the upper end of the plugging cylinder 32 is plugged in the first annular cylinder 12, and the inner wall of the upper end of the socket cylinder 33 is connected to the outer wall of the lower end of the plugging cylinder 32. The diameter of the socket cylinder 33 is larger than that of the plugging cylinder 32. The central tube 20 is plugged in the plugging cylinder 32, to form mounting space between the inner wall of the socket cylinder 33 and the outer wall of the central tube 20.

In the above embodiments, when assembling the central tube 20, first the second sealing ring 50 is embedded in the second sealing groove 314, then the central tube 20 passes the second sealing ring 50. However, limited to the wall thickness of the first connecting cylinder 31 itself, the depth of the second sealing groove 314 is small, which is disadvantageous for the stable mounting of the second sealing ring 50. And the friction force generated by the central tube 20 and the second sealing ring 50 when the central tube 20 passes through the second sealing ring 50, causes the second sealing ring 50 to fall off or be displaced from the second sealing groove 314, thereby failing to achieve a stable sealing. Therefore, in some embodiments, the second sealing groove 314 is adjacent to and penetrating through the lower end of the plugging cylinder 32, to allow the second sealing groove 314 to communicate with the annular space, so that the lower surface of the second sealing ring 50 faces the mounting space. The fixing member 60 fixed in the mounting space abuts against the lower surface of the second sealing ring 50, to press the second sealing ring 50 in the second sealing groove 314, which makes the mounting of the second seal ring 50 simpler and more reliable, and improves the sealing performance between the central tube 20 and the plugging cylinder 32, thereby improving the overall sealing performance of the water treatment apparatus.

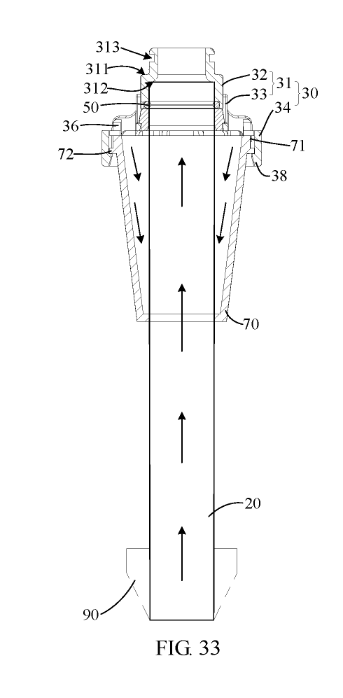

Further, as shown in FIGS. 33-36, the fixing member 60 has two cut-through ends and is disposed in the mounting space. The outer peripheral wall of the fixing member 60 is provided with a clamping buckle 61, the socket cylinder 33 is further opened with a clamping hole 331 adapted to the clamping buckle 61. In some embodiments, the fixing member 60 extends along the circumferential direction of the mounting space, to increase the contact area with the second sealing ring 50, so that the mounting of the second sealing ring 50 is more stable. The central tube 20 passes through the fixing member 60 and the second sealing ring 50 and is plugged in the plugging cylinder 32. The limiting surface of the clamping buckle 61 faces downward and is clamped with the lower edge of the clamping hole 331, to form an upwardly supporting-pressing force on the second sealing ring 50. The quantity of the clamping buckle 61 are plural, and the plural clamping buckles 61 are spaced apart along the circumferential direction of the fixing member 60. The number and shape of the clamping holes 331 correspond to the clamping buckles 61, to allow the connection between the fixing member 60 and the socket cylinder 33 more stable.

Further, as shown in FIGS. 30-36, the mounting head 11 further includes a second annular cylinder 13 annularly disposed on the outer periphery of the first annular cylinder 12. The water-outlet passage 131 is formed between the first annular cylinder 12 and the second annular cylinder 13. The connecting seat 30 includes a second connecting cylinder 34 adjacent to the socket cylinder 33 along the circumferential direction thereof. The water-passing runner 35 is formed between the inner wall of the second connecting cylinder 34 and the outer wall of the socket cylinder 33. The water-passing runner 35 communicates with the water-outlet passage 131. The water treatment apparatus further includes an upper water distributor 70 that is annularly disposed on the periphery of the central tube 20 and communicates with the water-outlet passage 131, the upper water distributor 70 is plugged in the second connecting cylinder 34.

In some embodiments, the lower end of the second annular cylinder 13 sticks out from the first annular cylinder 12, the second connecting cylinder 34 is exposed of the mounting head 11, and the lower end wall of the second annular cylinder 13 abuts against the upper end wall of the second connecting cylinder 34, to allow an abutting cooperation between the second connecting cylinder 34 and the second annular cylinder 13. The water-passing runner 35 communicates with the water-outlet passage 131, the upper water distributor 70 communicates with the water-passing runner 35. The upper water distributor 70 is configured to balance the amount of water per unit cross-sectional area, making the raw water more dispersed into the ion exchange tank 80, so as to increase the contact area between the raw water and the exchange filter in the ion exchange tank 80. Thereby, the efficiency of ion exchange is improved, and water production efficiency and water quality of softened water is improved. A water distribution space is formed between the inner wall of the upper water distributor 70 and the outer wall of the central pipe 20. The raw water flows from the water-outlet passage 131 through the water-passing runner 35 and the water distribution space into the ion exchange tank 80 for ion exchange to form softened water, and the softened water flows through the central tube to the water-inlet passage 121.

The upper water distributor 70 is plugged in the second connecting cylinder 34, that is, the upper water distributor 70 is plugged in the connecting seat 30. Therefore, the upper water distributor 70 does not need to be directly mounted in contact with the second annular cylinder 13, that is, the second annular cylinder 13 does not need to be formed into a structure for fixing the upper water distributor 70, which simplifies the overall structure of the water softener valve 10, and makes the mounting of the upper water distributor 70 and the water softener valve 10 simpler and more convenient. In addition, if during assembly, the upper water distributor 70 and the connecting seat 30, or the connecting seat 30 and the mounting head 11, are abnormally misaligned, since the connecting rod 30 between the upper water distributor 70 and the mounting head 11 is subjected to the force due to the assembly displacement, therefore, it's easier to disassemble the abnormally assembled the upper water distributor 70 and the water softener valve 10, and no damage would be caused to the upper water distributor 70 and the water softener valve 10, that is, the water softener valve 10 would not be scrapped directly, just replacing the connecting seat 30 would be fine. This reduces the risk of damage to the water softener valve 10 during assembly, thereby reducing the proportion of defective products, and the production cost caused by the defective products.

Further, as shown in FIGS. 30-33, the inner wall of the connecting base 30 is provided with a first clamping protrusion 37, a limiting surface of the first clamping protrusion 37 faces the water softener valve 10. The outer wall of the upper water distributor 70 is provided with a first flange 71 extending along the circumferential direction, and the first flange 71 overlap joints with the limiting surface of the first protrusion 37. In some embodiments, the limiting surface of the first clamping protrusion 37 abuts against the lower surface of the first flange 71. In some embodiments, the quantity of the first clamping protrusion 37 is plural, and the plural first clamping protrusions 37 are spaced apart along the circumferential direction, to make the mounting of the upper water distributor 70 and the connecting seat 30 more stable.

Further, as shown in FIGS. 30-33, the outer wall of the upper water distributor 70 is further provided with a second flange 72 extending along the circumferential direction on the side of the first flange 71 away from the water softener valve 10. The inner wall of the connecting seat 30 is provided with a second clamping protrusion 38 adapted to the second flange 72. In some embodiments, the second flange 72 is disposed at the lower side of the first flange 71, the second clamping protrusion 38 is disposed at the lower side of the first clamping protrusion 37, and a limiting surface of the second clamping protrusion 38 upwardly abuts against the lower surface of the second flange 72. In some embodiments, the quantity of the second clamping protrusion 38 is plural, and the plural second clamping protrusions 38 are spaced apart along the circumferential direction, to make the mounting of the upper water distributor 70 and the connecting seat 30 more stable.

Further, as shown in FIG. 30, the quantity of the first clamping protrusion 37 is plural, and the plural first clamping protrusions 37 are spaced apart along the circumferential direction; the quantity of the second clamping protrusion 38 is plural, and the plural second clamping protrusions 38 are spaced apart along the circumferential direction; the plural first clamping protrusions 37 and the plural second clamping protrusions 38 are staggered along the axial direction of the connecting base 30. In this embodiment, the first clamping protrusions 37 and the second clamping protrusions 38 are staggered arranged, facilitating the clamping or disassembly of the first flange 71 and the second flange 72, and convenient for the production of the first clamping protrusion 37 and the second clamping protrusion 38. In some embodiments, the first clamping protrusion 37 and the second clamping protrusion 38 are respectively provided with a first guiding inclined surface and a second guiding inclined surface inclined downward, to facilitate the first flange 71 and the second flange 72 respectively extending upwardly to the first guiding inclined surface and the second guiding inclined surface, then sliding to the limiting surfaces of the first clamping protrusion 37 and the second clamping protrusion 38, making the mounting of the upper water distributor 70 is simpler and more convenient.

Further, as shown in FIGS. 30-33, the connecting seat 30 further includes a connecting rib 36 which connects the inner wall of the second connecting cylinder 34 and the outer wall of the socket cylinder 33. The quantity of the connecting rib 36 is plural, and the plural connecting ribs 36 are spaced apart along the circumferential direction of the water-passing runner 35. In some embodiments, the connecting rib 36 is configured to connect the socket cylinder 33 and the second connecting cylinder 34, that is, to connect the first connecting cylinder 31 and the second connecting cylinder 34, and also configured to straighten and stabilize the water flowing through the water-passing runner 35. When the water softener valve 10 is operated under a high water pressure, since the water passing area of the water-passing runner 35 is small, the high pressure water flow is easily turbulent when passing through the water-passing runner 35, resulting in unsmooth water flow, and reducing the stability of water production of the water treatment apparatus. The plural connecting ribs 36 are arranged at intervals along the circumferential direction of the water-passing runner 35, to effectively guide and divert the water flowing therethrough, so that the water flowing through the water-passing runner 35 is more orderly and stable, and the overall stability of the water treatment equipment is improved.

Further, as shown in FIG. 31, the width of the connecting rib 36 is increased from the end adjacent to the first connecting cylinder 31 toward the end adjacent to the second connecting cylinder 34. In some embodiments, the connecting rib 36 includes a drain portion 361 connected to the first connecting cylinder 31, a guiding portion 363 connected to the second connecting cylinder 34, and a dividing portion 362 connecting the drain portion 361 and the guiding portion 363. The drain portion 361 is configured to guide the water flowing in a chaotic direction to flow along the axial direction; the dividing portion 362 is configured to separate the water flowing therethrough, that is, to divide the turbulent water flow guided by the drain portion 361 into a stable flow of small strands, in order to flow more stably through the water-passing runner 35; and the width of the guiding portion 363 is increased from the top to the bottom to form two guiding slopes facing away from each other, so that the small-flow water flowing through the dividing portion 362 flows more quickly to form a stable large-flow water flow through the water-passing runner 35, thereby increasing the flow rate and flow amount of the water flowing out of the water-passing runner 35. It should be understood that, the drainage portion 361 and the first connecting cylinder 31 as well as the dividing portion 362, the guiding portion 363 and the second connecting cylinder 34 as well as the dividing portion 362 are all connected by a smooth curved surface, to improve the straightening stability effect on the water flow.

Further, as shown in FIG. 30, the inner wall of the second connecting cylinder 34 adjacent to the first connecting cylinder 31 is provided with a protrusion rib 341. The connecting rib 36 connects to the protrusion rib 341. The protrusion rib 341 is protruded from the upper end of the second connecting cylinder 34 and extends intermittently in the circumferential direction, to facilitate the draft molding of the first clamping protrusion 37 and the second clamping protrusion 38. The protrusion rib 341 is configured to strengthen the connection strength between the connecting rib 36 and the second connecting passage, to improve the structural strength of the connecting seat 30. In addition, the upper surface of the first flange 71 abuts against the lower surface of the protrusion rib 341, to limit the first flange 71 between the protrusion rib 341 and the first clamping protrusion 37, further limiting the upper water distributor 70. In some embodiments, the lower end of the first connecting cylinder 31 is further provided with a strengthening rib 332. The connecting rib 36 is connected to the strengthening rib 332, to strengthen the connection strength between the connecting rib 36 and the first connecting cylinder 31, so as to improve the overall structural strength of the connecting seat 30.

Further, the first connecting cylinder 31, the second connecting cylinder 34 and the connecting rib 36 are integrally arranged. In some embodiments, the first connecting cylinder 31, the second connecting cylinder 34 and the connecting rib 36 are integrally arranged, in order to facilitate the integrated injection molding of the connecting seat 30, thereby reducing the processing steps and the production cost.

The disclosure further provides a water treatment apparatus. The water treatment apparatus includes a water softener valve 10, a central tube 20, an upper water distributor 70, an ion exchange tank 80 and a connecting member. The specific structure of the connecting member refers to the above embodiments. Since the water treatment apparatus adopts all the technical solutions of the above embodiments, at least, the water treatment apparatus obtains all the effects brought by the technical solutions of the above embodiments, which are to be detailed herein. The water softener valve 10 is provided with a mounting head 11, the ion exchange tank 80 is provided with an exchange port 81, the connecting seat 30 is plugged in the mounting head 11, the upper water distributor 70 and the central tube 20 are both plugged in the connecting seat 30, the mounting head 11 is mounted at the exchange port 81 to allow the inner cavity of the water softener valve 10 to communicate with the inner cavity of the ion exchange tank 80.

In this embodiment, the connecting seat 30 is plugged in the mounting port, the upper water distributor 70 and the central tube 20 are both plugged in the connecting seat 30, the mounting head 11 is plugged in the exchange port 81, therefore, the connecting seat 30, the upper water distributor 70 and the central tube 20 are located in the inner cavity of the ion exchange tank 80 together with the mounting head 11, to allow the inner cavity of the ion exchange tank 80 to communicate with the inner cavity of the water softener valve 10 via the upper water distributor 70 and the central tube 20, realizing soft water production. The mounting head 11 is screwed to the exchange port 81. The lower end of the central tube 20 is optionally provided with a lower water distributor 90, to equalize the amount of softened water flowing to the central tube 20 per unit area, thereby increasing the flow rate and flow amount of the softened water flowing to the water softener valve 10, so that the overall working efficiency of the water treatment apparatus is improved.

The foregoing description merely portrays some illustrative embodiments in accordance with the disclosure and therefore is not intended to limit the patentable scope of the disclosure. Any equivalent structure or flow transformations that are made taking advantage of the specification and accompanying drawings of the disclosure and any direct or indirect applications thereof in other related technical fields shall all fall in the scope of protection of the disclosure.

What is claimed is:

1. A water softener valve, comprising:
a valve body, a multi-way valve, a saline solution suction and water injection valve and a driving mechanism, the saline solution suction and water injection valve comprising a first valve rod, the driving mechanism comprising a mounting seat and a cam, the end of the first valve rod extending out of the valve body being transmission cooperated with the cam, wherein,
the mounting seat is defined with a sliding connection structure, the outer end of the first valve rod is sliding fit with the sliding connection structure along longitudinal direction, and the outer end of the first valve rod is position-limiting cooperated with the sliding connection structure along lateral direction; the longitudinal direction coincides with the length direction of the first valve rod, the lateral direction is perpendicular to the longitudinal direction and the axial direction of the cam.

2. The water softener valve of claim 1, wherein, the sliding connection structure is defined with two guiding surfaces opposite to each other along the lateral direction, the outer end of the first valve rod extends into and locates between the two guiding surfaces and is sliding fit with the two guiding surfaces along the longitudinal direction.

3. The water softener valve of claim 2, wherein, the outer end of the first valve rod is defined with a sliding cooperation portion sliding fit with the sliding connection structure, the sliding cooperation portion is defined with two sliding connection surfaces that protrude from the outer peripheral surface of the first valve rod and slide fit with the two guiding surfaces respectively.

4. The water softener valve of claim 1, wherein, the valve body is defined with a water-passing passage and a water-passing port communicating with one end of the water-passing passage, the valve body is defined with a plug interface extending through the side wall of the water-passing passage and adjacent to the water-passing port; the water softener valve further comprises a water-passing connector and a fixing member, the water-passing connector is plugged in the water-passing port, two ends of the water-passing connector are cut-through and communicate with the water-passing passage; the fixing member is plugged in the plug interface, and caught at the portion of the water-passing connector located in the water-passing passage, to at least limit the water-passing connector along the axial direction of the water-passing connector.

5. The water softener valve of claim 4, wherein, the fixing member comprises a pin, the pin extends into the water-passing passage through the plug interface, and is clamped on the outer peripheral wall of the water-passing connector.

6. The water softener valve of claim 5, wherein, the fixing member further comprises a connecting plate defined on the outer side of the plug interface, the quantity of the pin is two, the two pins are connected to one side of the connecting plate and spaced apart with each other, the two pins are clamped at two opposite positions on the outer peripheral wall of the water-passing connector.

7. The water softener valve of claim 1, wherein, the water softener valve further comprises a piston assembly, the piston assembly comprises a piston body, a piston rod, a connecting member, and a fastening member, the piston body is in an integrated structure, the piston assembly defines a water-passing passage extending along the telescopic direction of the piston rod and having two cut-through ends, the connecting member is defined on the piston rod, the connecting member is position-limiting cooperated with the piston rod along the telescopic direction, the fastening member cooperates with the piston body to limit the connecting member along the telescopic direction.

8. The water softener valve of claim 7, wherein, the connecting member and the piston rod are detachably connected, and the connecting member is defined in the inner end of the piston rod.

9. The water softener valve of claim 8, wherein, the outer peripheral surface of the piston rod is defined with an via hole, the connecting member has a bar-like shape and passes through the via hole.

10. The water softener valve of claim 1, wherein, the water softener valve further comprises a piston rod and a piston rod sealing structure, the valve body comprises a main body and an end cap, the main body is defined with a valve cavity having one end open, the end cap covers the open of the valve cavity, the end cap is defined with a mounting hole for the piston rod to come in or out of the valve cavity;
the piston rod sealing structure comprises a sealing ring, being annularly defined at the edge of the mounting hole and configured to sealingly fit with the piston rod; and a fixing member, being fixedly connected to the end cap, to fix the sealing ring.

11. The water softener valve of claim 10, wherein, the end cap is defined with a mounting groove, the mounting hole is defined in the bottom wall of the mounting groove, the sealing ring is defined in the mounting groove, and the fixing member is fixed in the mounting groove.

12. The water softener valve of claim 11, wherein, the outer peripheral surface of the end cap is defined with a mounting post, the mounting groove is defined on the top of the mounting post.

13. A water treatment apparatus comprising:
a water softener valve, the water softener valve comprises a valve body, a multi-way valve, a saline solution suction and water injection valve and a driving mechanism, the saline solution suction and water injection valve comprises a first valve rod, the driving mechanism comprises a mounting seat and a cam, the end of the first valve rod extending out of the valve body is transmission cooperated with the cam, the mounting seat is defined with a sliding connection structure, the outer end of the first valve rod is sliding fit with the sliding connection structure along the longitudinal direction, and the outer end of the first valve rod is position-limiting cooperated with the sliding connection structure in the lateral direction; the longitudinal direction coincides with the length direction of the first valve rod, the lateral direction is perpendicular to the longitudinal direction and the axial direction of the cam.

14. The water treatment apparatus of claim 13, wherein, the driving mechanism comprises a housing and a transmission shaft, the cam comprises a first cam and a second cam, the multi-way valve is transmission connected with the first cam, the saline solution suction and water injection valve is transmission connected with the second cam, the inner cavity of the housing is defined with a first mounting surface; the axes of the first cam, the second cam and the transmission shaft are arranged in parallel with each other, the outer peripheral surfaces of the first cam and the second cam are both defined with gear rack rows, the transmission shaft is defined between the first cam and the second cam, the transmission shaft is defined with a first tooth segment engaged with the first cam, and a second tooth segment engaged with the second cam, the first cam is adjacent to the first mounting surface, the second cam and the first mounting surface defines a mounting space therebetween.

15. The water treatment apparatus of claim 14, wherein, the inner cavity of the housing is defined with a second mounting surface facing the first mounting surface, the outer end of the valve rod of the saline solution suction and water injection valve is defined between the second mounting surface and the second cam.

16. The water treatment apparatus of claim 13, wherein, the water treatment apparatus further comprises an upper water distributor and a connecting assembly, the water softener valve is defined with a mounting head, the connecting assembly comprises a connecting seat, two ends of the connecting seat are cut-through and the connecting seat is plugged in the mounting head, the upper water distributor is plugged in the connecting seat and communicates with the valve cavity of the water softener valve.

17. The water treatment apparatus of claim 16, wherein, the inner wall of the connecting seat is defined with a first clamping protrusion, a limiting surface of the first clamping protrusion faces the water softener valve, the outer wall of the upper water distributor is defined with a first flange extending circumferentially, the first flange overlap joints with the limiting surface of the first clamping protrusion.

18. The water treatment apparatus of claim 16, wherein, the connecting seat comprises a first connecting cylinder and a second connecting cylinder adjacent sequentially along the axial direction of the connecting seat, the first connecting cylinder is plugged in the mounting head, the second connecting cylinder is exposed of the mounting head, the upper water distributor is plugged into the second connecting cylinder; the outer wall of the first connecting cylinder and the inner wall of the second connecting cylinder define an annular water-passing passage therebetween, the connecting seat further comprises a connecting rib connecting the outer wall of the first connecting cylinder with the inner wall of the second connecting cylinder.

19. The water treatment apparatus of claim 13, wherein, the water treatment apparatus further comprises a central tube and a connecting assembly, the water softener valve is defined with a mounting head, the connecting assembly comprises a connecting seat, two ends of the connecting seat are cut-through and the connecting seat is plugged in the mounting head, the central tube is plugged in the connecting seat to communicate with the valve cavity of the water softener valve.

20. The water treatment apparatus of claim 19, wherein, the mounting head comprises a first annular cylinder, the first annular cylinder defines a water-inlet passage; the connecting seat comprises a first connecting cylinder, the first connecting cylinder is plugged in the first annular cylinder, the central tube is plugged in the first connecting cylinder, to communicate with the water-inlet passage.
